(19) United States
(12) Patent Application Publication
(10) Pub. No.: US 2026/0291893 A1
(43) Pub. Date: Sep. 24, 2026

(54) SYSTEM

(71) Applicant: SoftBank Group Corp., Tokyo (JP)

(72) Inventor: Hiroyuki YAMAUCHI, Tokyo (JP)

(73) Assignee: SoftBank Group Corp., Tokyo (JP)

(21) Appl. No.: 19/567,438

(22) Filed: Mar. 16, 2026

(30) Foreign Application Priority Data
Mar. 19, 2025 (JP) 2025-045119

(51) Int. Cl. H04L 51/02; G06N 20/00

(52) U.S. Cl. CPC H04L 51/02; G06N 20/00

(57) ABSTRACT

A system includes a processor that is configured to receive, as an input, an emotional expression or a thought of a user and analyze the input by using a natural language processing technique to identify at least a type and an intensity of an emotion included in the input, generate, based on a result of the analysis, a prompt for instructing a generative artificial intelligence model to generate a natural text, and provide feedback on the generated text, the feedback including one or more specific points for improvement of the generated text.

### CROSS-REFERENCE TO RELATED APPLICATION

This application is based on and claims priority under 35 USC 119 from Japanese Patent Application No. 2025-045119 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional text creation support systems and content creation tools merely provide templates, canned phrases, or simple rewriting functions, and therefore fail to adequately capture and reflect a user's actual emotions and thoughts in a nuanced manner. As a result, a user often cannot effectively express a type and intensity of the user's own emotions in a natural written form, especially in emotionally important situations such as proposals, apologies, or expressions of gratitude. In addition, known generative artificial intelligence models require the user to manually design and input complex prompts in order to obtain a text output that matches the user's emotional state and usage context. This imposes a cognitive and operational burden on the user and frequently leads to generated texts that are unnatural or misaligned with the user's intended feelings. Furthermore, conventional systems rarely provide concrete, actionable feedback indicating how a generated text should be improved, and thus provide little support for iterative refinement of the text or for long-term improvement of the user's expressive ability. Still further, existing systems do not sufficiently address real-time changes in a user's emotional state, and do not adapt feedback in accordance with such changes. Moreover, when a generated text is to be distributed as user-generated content via a content distribution service, known systems do not optimize prompts to a generative artificial intelligence model in view of the format or constraints of the distribution platform, which can result in suboptimal presentation and reduced engagement. Accordingly, there is a need for a system that can: analyze a user's emotional input with sufficient granularity, automatically generate appropriate prompts for a generative artificial intelligence model, provide specific improvement feedback on generated texts, dynamically respond to real-time emotional changes, and optimize prompts for distribution of user-generated content in an appropriate format.

### SUMMARY

In order to solve at least the above problems, an embodiment of the present invention provides a system comprising a processor, wherein the processor is configured to receive, as an input, an emotional expression or a thought of a user and analyze the input by using a natural language processing technique to identify at least a type and an intensity of an emotion included in the input. By performing such analysis, the processor creates an internal representation of the user's emotional state and contextual intent. The processor is further configured to generate, based on a result of the analysis, a prompt for instructing a generative artificial intelligence model to generate a natural text. In particular, the processor can automatically construct a prompt that encodes the identified emotion type, emotion intensity, target audience, and usage scenario so that the generative artificial intelligence model produces a text closely aligned with the user's underlying feelings. The processor is also configured to provide feedback on the generated text, the feedback including one or more specific points for improvement of the generated text, such as suggestions for adding detail, clarifying emotional nuance, adjusting tone, or modifying structure. According to another aspect, the processor is configured to track, in real time, a change in the emotion of the user, for example by periodically receiving new emotional input or updates from the user, and to generate feedback that reflects the change in the emotion, thereby enabling dynamic adaptation of the suggested text and feedback as the user's feelings evolve. According to a further aspect, when the generated text is to be distributed as user-generated content via a content distribution service, the processor is configured to optimize the prompt so as to instruct the generative artificial intelligence model to provide content in an optimum format that conforms to constraints and best practices of a target platform, such as maximum length, layout, or style guidelines. Through these configurations, the system can support the user in generating natural texts that more accurately express the user's emotions, can provide concrete and iterative feedback for improvement, can respond to real-time emotional changes, and can output user-generated content in a format suitable for various content distribution services.

The term “processor” refers to one or more hardware processing units, such as a central processing unit (CPU), a graphics processing unit (GPU), a digital signal processor (DSP), or any combination thereof, configured to execute instructions to perform the functions described in the present specification.

The term “user” refers to a human operator who interacts with the system by providing emotional expressions or thoughts as input and by receiving generated texts and feedback from the system.

The term “emotional expression” refers to any natural language text, phrase, sentence, or collection of sentences input by the user that conveys the user's feelings, mood, or affective state, including but not limited to happiness, sadness, gratitude, anger, anxiety, affection, or love.

The term “thought” refers to any natural language text, phrase, sentence, or collection of sentences input by the user that conveys the user's ideas, opinions, intentions, reflections, or mental states, irrespective of whether such text explicitly includes emotional words.

The term “natural language processing technique” refers to any computational method, algorithm, or model for processing, analyzing, or understanding human language expressed in natural language form, including but not limited to tokenization, parsing, sentiment analysis, named entity recognition, classification, and embedding-based analysis.

The term “type of an emotion” refers to a categorical label or classification indicating a kind of emotion contained in the user's input, such as joy, sadness, anger, fear, surprise, disgust, gratitude, affection, or any other distinguishable emotional category.

The term “intensity of an emotion” refers to a degree or strength associated with an identified type of emotion, which may be represented, for example, as a numerical score, a discrete level (such as low, medium, or high), or another scale indicating how strongly the emotion is expressed in the input.

The term “analysis result” refers to information obtained from processing the user's input using the natural language processing technique, including at least the identified type and intensity of the emotion, and optionally additional features such as key phrases, topics, or contextual attributes.

The term “prompt” refers to a text, instruction set, or structured data provided to a generative artificial intelligence model, which specifies conditions, constraints, style, content requirements, or other guidance for generating a natural text output.

The term “generative artificial intelligence model” refers to a machine learning model configured to generate natural language text in response to a prompt, including but not limited to large language models, sequence-to-sequence models, transformer-based models, or other neural network-based text generation systems.

The term “natural text” refers to a sentence or set of sentences generated in a human language that is grammatically correct or generally understandable, and that is suitable for human reading in ordinary communication settings.

The term “feedback” refers to information provided to the user, based on analysis of a generated text, that indicates one or more specific aspects of the text and includes guidance, evaluation, or suggestions for modification or improvement.

The term “specific point for improvement” refers to a concrete suggestion, comment, or instruction regarding a portion of the generated text, such as adding or removing content, changing wording or tone, clarifying meaning, adjusting structure, or modifying length.

The term “real time” refers to operation in which the system processes user inputs and updates feedback or analysis with a responsiveness that is sufficiently immediate for the user to perceive the system as responding without substantial delay during an ongoing interaction.

The term “change in the emotion of the user” refers to a variation over time in at least one of the type or intensity of an emotion expressed by the user, as determined from one or more successive inputs or updates from the user.

The term “content distribution service” refers to an online platform, website, application, or network service through which digital content, including but not limited to text, images, audio, or video, is distributed or published to other users, such as social networking services, blogging platforms, video sharing sites, or messaging services.

The term “user-generated content” refers to content, including at least text generated or edited with assistance from the system, that is created or approved by the user and is intended to be distributed or published through a content distribution service.

The term “optimum format” refers to a format of content that conforms to constraints, guidelines, or best practices defined by a target content distribution service, including but not limited to limitations on length, layout, style, metadata, or tagging, in a manner that is expected to enhance readability, compatibility, or engagement on that service.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

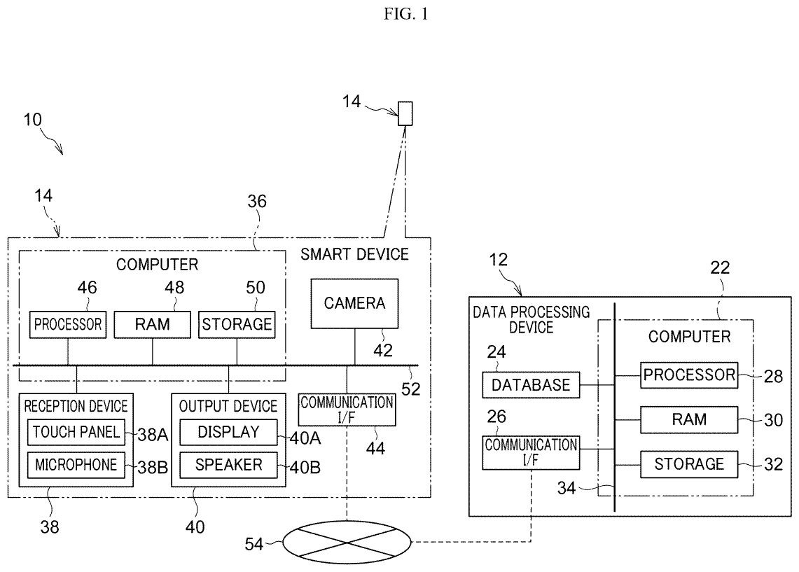

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

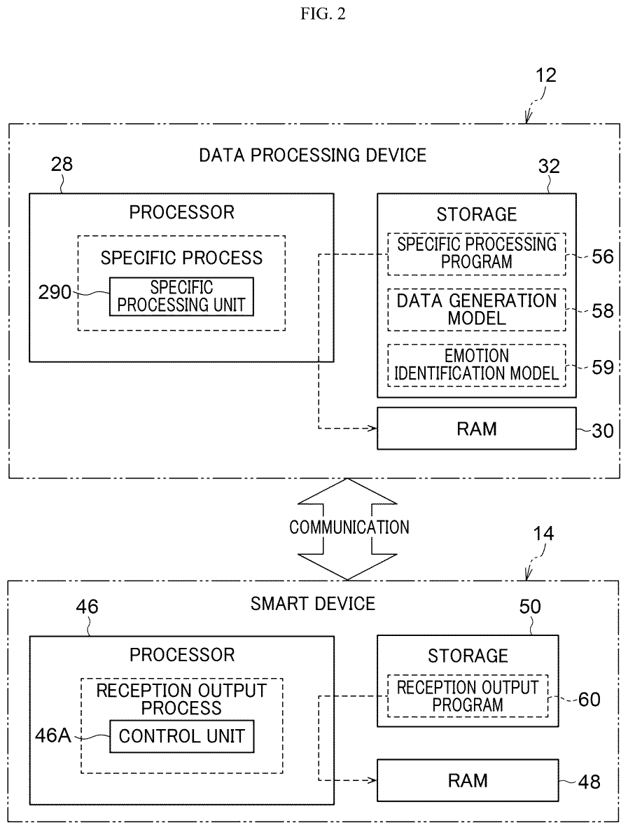

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional computer-implemented writing support systems that utilize natural language processing or generative models typically accept a single user input, invoke a text generation engine, and return a one-time output. Such systems are often designed as simple front-ends to a generative model and do not provide a structured interaction loop between the user, the terminal, and the server. As a result, these systems suffer from multiple technical limitations.

First, conventional systems do not manage prompt sentences and generated texts as structured data objects suitable for machine processing on the server side. The lack of structured handling of prompt sentences, model input data, and feedback data on the server restricts the system's ability to perform consistent control over iterative interactions and to adapt subsequent model calls based on prior interactions. This leads to inefficient use of computing resources because the generative model is repeatedly invoked in an unoptimized, stateless fashion, and because the server cannot systematically leverage accumulated interaction data to improve subsequent processing.

Second, conventional systems generally do not integrate, at the server level, an automated mechanism for generating feedback data that evaluates generated text and provides specific improvement points, and then feeding that feedback back into subsequent prompt sentences. In many existing approaches, evaluation and revision are left entirely to the human user or are performed in an ad hoc manner on the client, resulting in inconsistent guidance and additional cognitive burden on the user. From a computing standpoint, the absence of a server-controlled feedback generation and control loop prevents the system from programmatically steering user inputs toward forms that are easier for the generative AI model to process efficiently and accurately.

Third, existing systems rarely generate input guide information on the server based on previously generated feedback data and then use that information to dynamically guide future prompt sentence inputs. Without such server-side guidance, user inputs can be noisy, excessively long, or vague, which increases processing time, modeling complexity, and resource consumption on the server, and often degrades the quality and stability of model outputs. The lack of a feedback-driven input guidance mechanism thus results in suboptimal utilization of network bandwidth, memory, and processor cycles on the server and associated hardware resources.

Fourth, conventional systems do not systematically store and analyze sets of prompt sentences, generated texts, and feedback data in a manner that allows the server to automatically update generation conditions for model input data or feedback data. As a consequence, the system cannot exploit historical interaction data to improve the configuration of model calls, such as parameter selection or prompt templates, over time. This leads to a static system behavior that does not adapt to actual usage patterns and imposes a persistent inefficiency in how computational resources are allocated for inference and evaluation tasks.

Accordingly, there is a need for a computer-implemented system that, on the server side, (i) acquires and structures prompt sentences from a terminal, (ii) controls server-side interaction with a generative AI model to generate text data, (iii) automatically generates feedback data including evaluation information and improvement points, (iv) guides subsequent user inputs using input guide information derived from feedback data, and (v) stores and processes interaction sets to update generation conditions. Such a system should improve the technical operation of the server and associated information processing apparatus by enabling more efficient, adaptive, and iterative control of generative AI model usage and user interaction flows.

The specific processing by the specific processing unit 290 of the data processing device 12 in Example 1 is realized by the following means.

The present invention provides a server comprising a processor configured to acquire, via a terminal, text data including a user's feelings or thoughts as a prompt sentence from the user, generate structured data representing the prompt sentence, generate model input data for input to a generative AI model based on the structured data, transmit the model input data to the generative AI model so as to cause the generative AI model to generate text data expressed in natural language, acquire the generated text data, cause the generative AI model or an evaluation information processing apparatus to generate feedback data including evaluation information and improvement points for content of expression in the text data based on the prompt sentence and the text data, acquire the feedback data, transmit the text data and the feedback data to the terminal so as to cause the terminal to present the text data and the feedback data to the user, acquire, from the user via the terminal, revised text data as a new prompt sentence revised based on the feedback data, and perform control to repeatedly execute processing for generation of the text data by the generative AI model and processing for generation of the feedback data, further configured to generate, in accordance with content of the feedback data presented on the terminal, input guide information regarding at least one of length, specificity, and degree of emotional expression of the prompt sentence to be input by the user, transmit the input guide information to the terminal so as to cause the terminal to display the input guide information and thereby guide a subsequent input of the prompt sentence by the user, and store, in a storage medium, sets each including the prompt sentence, the text data, and the feedback data in association with identification information and execute at least one of statistical processing and machine learning processing on a plurality of the stored sets so as to update at least one of a generation condition for the model input data to be supplied to the generative AI model and a generation condition for the feedback data. This enables the server to control an iterative interaction loop in which prompt sentences, model input data, generated text data, and feedback data are managed as structured objects, to dynamically guide user inputs based on previously generated feedback data, and to adapt generation conditions over time using stored interaction sets, thereby improving computational efficiency, stability, and quality of generative AI model usage on the server.

The term “system” refers to a combination of at least one server, at least one terminal, and associated communication and storage components that cooperate to execute the claimed processing.

The term “processor” refers to one or more hardware processing units, such as central processing units or graphics processing units, configured to execute instructions to perform the functions described in the claims.

The term “terminal” refers to an information processing device, such as a portable communication device, a personal computing device, or a display-equipped input device, that enables a user to input data and receive data from the server.

The term “user” refers to a human operator who interacts with the terminal by providing input data and viewing or otherwise consuming output data.

The term “text data” refers to information expressed as a sequence of characters encoded in a machine-readable format.

The term “prompt sentence” refers to text data provided by the user that includes at least a portion of the user's feelings or thoughts and serves as input for further processing by a generative AI model.

The term “structured data” refers to data representing at least part of the prompt sentence in a machine-processable format, such as a record, a key-value structure, or another predefined data structure.

The term “model input data” refers to data generated on the basis of the structured data and formatted according to an input specification of a generative AI model.

The term “generative AI model” refers to an information processing model implemented using artificial intelligence techniques that receives model input data and generates text data expressed in natural language.

The term “text data expressed in natural language” refers to a sequence of characters generated by the generative AI model that conforms to linguistic rules of a human language and represents extended content based on the prompt sentence.

The term “evaluation information” refers to information that assesses at least one aspect of the generated text data, including but not limited to clarity, completeness, emotional expression, or structural quality.

The term “improvement points” refers to information indicating one or more specific modifications or enhancements that can be applied to the generated text data to improve its quality.

The term “feedback data” refers to data including at least the evaluation information and the improvement points regarding the generated text data.

The term “evaluation information processing apparatus” refers to an information processing device or module, separate from or integrated with the generative AI model, configured to generate feedback data based on at least the prompt sentence and the generated text data.

The term “input guide information” refers to information generated on the basis of feedback data that indicates how the user should adjust a subsequent prompt sentence, including at least one of length, specificity, and degree of emotional expression.

The term “revised text data” refers to text data provided by the user after modification based on the feedback data and used as a new prompt sentence.

The term “storage medium” refers to any non-transitory computer-readable medium capable of storing data, such as a semiconductor memory, a magnetic storage device, or an optical storage device.

The term “identification information” refers to data used to associate each stored set of prompt sentence, text data, and feedback data with a unique identifier.

The term “set” refers to a logically grouped collection of related data elements including at least one prompt sentence, corresponding generated text data, and corresponding feedback data.

The term “statistical processing” refers to processing that applies mathematical or statistical techniques to a plurality of sets to derive aggregated metrics or patterns.

The term “machine learning processing” refers to processing that uses one or more algorithmic models to learn from a plurality of sets and adjust parameters or rules for subsequent processing.

The term “generation condition” refers to one or more parameters, templates, control values, or rules used when generating model input data or feedback data.

The term “update” refers to modifying at least part of a generation condition based on results of statistical processing or machine learning processing applied to stored sets.

In the following embodiments, a system including at least one server and at least one terminal executes a generative AI-based writing support process. The claims are not limited to the specific embodiments described below; rather, these embodiments are provided to enable a person skilled in the art to implement the invention and to illustrate how the claimed configuration improves operation of computer technology.

### 1. Hardware and Software Configuration

### A. Server Configuration

The server includes at least one processor, at least one memory, at least one storage medium, and at least one network interface. The processor may be a central processing unit, a graphics processing unit, a tensor processing unit, or a combination thereof. The memory may be a volatile semiconductor memory such as dynamic random access memory. The storage medium may be a non-volatile storage device such as a solid-state drive or a magnetic disk. The network interface may support wired or wireless communication using an Internet protocol.

The server executes an operating system such as a general-purpose server operating system, and an application stack including:
a web application framework (for example, a framework for handling HTTP/HTTPS requests and responses),
a model inference component for a generative AI model,
a data management component for storing prompt sentences, generated text data, and feedback data as structured data objects, and
a control component for managing iterative interaction between the server, the terminal, and the user.

The server includes or accesses a generative AI model implemented as a neural network. In one embodiment, the generative AI model is a Transformer-based language model that includes an embedding layer, a plurality of self-attention layers, and a final output layer. The generative AI model maintains a vocabulary of token identifiers and parameters (weights and biases) optimized for natural language generation. The generative AI model may be deployed on the same hardware as the server or on a separate inference server reachable over a network.

The server stores program instructions which, when executed by the processor, cause the server to perform data processing operations such as tokenization of text data, generation of model input data, invocation of the generative AI model, calculation of evaluation information, generation of feedback data, and execution of statistical or machine learning processing on stored interaction sets.

### B. Terminal Configuration

The terminal includes at least one processor, a memory, an input interface, a display unit, and a communication interface. The terminal may be implemented as a portable communication device, a personal computing device, or another user-operable information processing device. The input interface may include a touch-sensitive display, a physical keyboard, a pointing device, a microphone, or a combination thereof. The display unit may be a liquid crystal display, an organic light-emitting diode display, or another visual display device.

The terminal executes an operating system for client devices and a client application or web browser. The terminal presents user interfaces for receiving prompt sentences from the user, displaying generated text data, and showing feedback data and input guide information received from the server. The terminal transmits and receives data to and from the server through the communication interface.

### C. User Interaction

The user operates the terminal to input text data expressing feelings or thoughts and to review generated text data and feedback data presented on the display unit. The user may iteratively refine text based on feedback, thereby providing revised text data that the server treats as new prompt sentences.

### 2. Data Structures and Internal Representations

### A. Prompt Sentence Representation

The server treats a prompt sentence as text data including a sequence of characters. The server internally represents the prompt sentence as structured data, for example, by associating the raw text string with metadata such as:
a language code,
a timestamp,
an anonymized user identifier,
a session identifier, and
a content-type label indicating that the text expresses feelings or thoughts.

By representing the prompt sentence as structured data, the server can perform consistent analysis, routing, and storage. For example, the server may maintain a record structure including fields for “prompt_text,” “language,” “user_id,” and “session_id.” This structured representation enables the server to efficiently query and batch-process multiple prompt sentences and to associate each prompt sentence with subsequent generated text data and feedback data.

### B. Model Input Data Representation

The server converts structured prompt sentence data into model input data suitable for the generative AI model. In one embodiment, the server creates an input sequence that combines:
a role or context indicator (for example, “instruction for writing assistant”),
a description of the task (for example, “expand this short feeling into a detailed paragraph”), and
the prompt sentence itself.

The server then tokenizes the combined string into token identifiers using the tokenizer associated with the generative AI model. The server may further construct an internal structure including:
an array of token identifiers,
a maximum length parameter,
decoding parameters such as temperature and top-p, and
control flags specifying output format or constraints.

This structured model input data allows the server to consistently control behavior of the generative AI model and to adjust parameters based on prior interactions or stored generation conditions.

### C. Generated Text Data Representation

The generative AI model outputs a sequence of token identifiers that the server converts to a text string. The server represents the generated text data as a structured object associated with the originating prompt sentence and session. For example, the server may maintain a record containing:
“generated_text” (the output text),
an identifier of the generative AI model used,
decoding parameters used for generation,
a generation timestamp, and
a reference to the associated prompt sentence record.

This representation permits later analysis, comparison, and feedback generation, and supports the statistical and machine learning processing described below.

### D. Feedback Data Representation

The server represents feedback data as structured data that includes evaluation information and improvement points. Evaluation information may include numeric or categorical scores for clarity, emotional depth, concreteness, and structural coherence. Improvement points may include textual suggestions such as “add a specific event” or “describe physical sensations.” The server may store feedback data using fields such as:
“clarity_score”,
“emotion_score”,
“concreteness_score”,
“structure_score”,
“suggestions_text”,
and references to the associated prompt sentence and generated text data.

This structured representation enables the server to generate input guide information from feedback data and to apply machine learning to determine how feedback data correlates with improvements in subsequent user inputs and generated outputs.

### 3. Generative AI Model Architecture and Learning

The generative AI model used by the server is, in one embodiment, a Transformer-based language model trained using a large corpus of natural language text. The model includes:
an embedding layer that maps token identifiers to continuous vector representations,
a plurality of encoder-decoder or decoder-only layers each including multi-head self-attention mechanisms and feedforward neural networks, and
an output layer that generates a probability distribution over tokens for each time step.

During initial training (which may be performed before deployment of the system), the model minimizes a loss function such as cross-entropy loss between predicted tokens and ground-truth tokens. Optimization algorithms, such as stochastic gradient descent with adaptive moment estimation, update the model's weight parameters based on gradients of the loss function. The model may be pre-trained on generic text and then fine-tuned on datasets emphasizing emotional expression and feedback.

The server may perform further adaptation of model usage at inference time by adjusting:
decoding parameters (such as temperature, top-k, or repetition penalty),
prompt templates used to compose model input data, and
selection of specific models or model variants based on context.

The server does not necessarily retrain the neural network in real time, but updates generation conditions stored in the storage medium and uses these conditions to configure subsequent model calls.

### 4. Feedback Generation and Evaluation Model

The server may employ the same generative AI model or a separate evaluation-focused model to generate feedback data. In one embodiment, the server constructs a specialized evaluation input that includes:
the original prompt sentence,
the generated text data, and
an instruction specifying evaluation criteria (for example, “evaluate clarity, emotional depth, and specificity”).

The server passes this evaluation input through an evaluation model that outputs a combination of structured scores and textual suggestions. The evaluation model may share the same architecture as the generative AI model but may be fine-tuned on pairs of texts and human-written feedback. During training, the evaluation model minimizes a loss function that measures deviation between predicted feedback and reference feedback, and may also incorporate auxiliary loss terms related to classification of quality levels.

By using a dedicated evaluation model that encodes domain-specific evaluation criteria and produces structured scores, the server performs a type of processing that is not merely human judgment automation; instead, the server executes a consistent, parameter-controlled evaluation that can be tuned and improved based on measurable error metrics.

### 5. Input Guide Information and Iterative Control

The server generates input guide information based on feedback data. For example, if feedback data repeatedly indicates that generated text data lacks concrete episodes, the server may generate guide information such as “Please add at least one specific event that caused your feeling” or “Please describe when and where the event occurred.”

The server may maintain rules or learned mappings that convert structured feedback attributes (such as low concreteness score) into specific guide messages. Machine learning algorithms can be applied to historical interaction sets to learn which guide messages lead to improved evaluation scores in subsequent iterations. For example, reinforcement learning or supervised learning can map feedback patterns to guide messages with the goal of maximizing improvements in clarity and emotional depth.

By dynamically generating input guide information and transmitting it to the terminal, the server reduces the occurrence of vague or excessively long prompt sentences. This leads to shorter input sequences for the generative AI model, thereby reducing token counts, memory usage, and computation time for generation. As a result, the technical operation of the server improves with respect to processing speed and resource utilization.

### 6. Storage and Analysis of Interaction Sets

The server stores sets of prompt sentences, generated text data, and feedback data in a storage medium, associated with identification information. The server may index these sets using keys such as session identifiers, timestamps, or category labels.

The server executes statistical processing on these sets to compute aggregated metrics such as:
average length of prompt sentences,
distribution of evaluation scores over time, and
correlation between specific types of input guide information and subsequent improvements in evaluation scores.

The server may further execute machine learning processing on these sets. For example, the server may train a model that predicts optimal decoding parameters or prompt templates based on features extracted from the prompt sentence and historical feedback data. Features may include numerical representations of sentiment strength, estimated reading level, or detected presence of episodic details. The server may use gradient-based optimization to minimize a loss function that measures deviation between predicted evaluation scores and observed evaluation scores, or that directly optimizes a composite utility metric derived from multiple evaluation dimensions.

By updating generation conditions for model input data and feedback data based on stored interaction sets, the server adaptively configures future inference operations. This adaptivity leads to more stable and higher-quality outputs for similar classes of inputs, and reduces the need to repeatedly search for effective parameter combinations manually, thereby improving computational efficiency.

### 7. Technical Effects and Improvement of Computer Technology

The described configuration produces several technical effects beyond mere automation of human writing or reviewing tasks:

### (1) Reduction of Computational Load Through Guided Inputs

Because the server generates input guide information derived from feedback data, the terminal presents specific guidance to the user about length, specificity, and emotional expression. The user consequently provides more focused prompt sentences, which typically contain fewer irrelevant or ambiguous segments. The server then encodes shorter and more structured model input data, reducing the number of tokens processed by the generative AI model. This directly reduces computation time and memory usage on the processing hardware.

### (2) Stabilization and Improvement of Model Outputs

The server uses structured feedback data and stored interaction sets to update generation conditions, such as decoding parameters and prompt templates. By applying statistical and machine learning processing to these stored sets, the server identifies parameter combinations that consistently yield higher evaluation scores. This feedback-driven parameter optimization reduces variance in output quality and improves repeatability of model behavior, which in turn enhances the reliability of the generative AI model when deployed on shared servers with constrained resources.

### (3) Efficient Data Management and Retrieval

By storing prompt sentences, generated text data, and feedback data as structured sets with identification information, the server can efficiently retrieve, batch, and analyze data using indexing and caching mechanisms. This structured data management supports online and offline optimization tasks and reduces overhead compared to unstructured log data. As a result, the server can perform more efficient database operations and reduce storage and retrieval latency.

### (4) Non-Conventional Interaction Control

The server imposes a non-conventional, iterative control loop over the generative AI model, feedback generation, and user inputs. This control loop is defined by specific rules, structured data formats, and parameter update mechanisms, which differ from simple one-time text generation systems. The server thus executes a specialized algorithm for managing prompt sentences, model calls, feedback evaluation, and input guidance. This algorithmic control is tailored to the architecture of the generative AI model and to storage and retrieval processes within the server, which improves overall computing performance compared to naive or stateless usage of a generative model.

### (5) Distinctive AI Processing Methods

The generative AI model and the evaluation model use trained weight parameters and attention-based mechanisms to process text data. These models operate according to learned distributions and feature representations that are not equivalent to human reasoning steps. For example, the evaluation model may use internal attention patterns and hidden state representations to estimate clarity or emotional depth scores based on patterns in token sequences rather than explicit rules. This non-human, parameterized approach allows the server to perform consistent and quantifiable evaluation and guidance at scale, which would be difficult for human operators to replicate with similar speed and uniformity.

### 8. Example of User Interaction and Data Flow

The user operates the terminal to input a prompt sentence such as:
“I feel very happy today.”

The terminal transmits this prompt sentence to the server. The server represents the sentence as structured data and then generates model input data that combines task instructions with the prompt sentence. The server tokenizes the combined text and passes the token sequence to the generative AI model. The generative AI model processes the token sequence through multiple attention layers and outputs a sequence of tokens which the server converts into generated text such as:
“Today has been a wonderful day. I spent joyful moments with my friends, and my heart feels truly fulfilled.”

The server then prepares an evaluation input including the original prompt sentence and the generated text and passes it to the evaluation model. The evaluation model calculates internal representation vectors and outputs evaluation scores and suggestions such as:
“The main feeling of happiness is clearly expressed, but adding a specific episode will make the scene more vivid.”

The server structures this feedback data, transmits it to the terminal, and also stores the prompt sentence, generated text, and feedback data as a set in the storage medium. The terminal displays the generated text and feedback to the user and, if input guide information is available, shows guidance such as “Please describe at least one event that made you happy.”

The user then revises the text based on the feedback, for example:
“Today has been a wonderful day. I went to the park with my closest friends, and we laughed together for hours. When I remember their smiles and the warm sunshine, my heart feels calm and full.”

The terminal transmits the revised text as a new prompt sentence. The server processes this new prompt sentence using generation conditions that have been updated based on previously stored sets, enabling improved generation quality and more efficient computation. Over time, as the server accumulates more sets and updates generation conditions via statistical and machine learning processing, the system becomes more effective at generating high-quality text and targeted feedback while reducing computational and communication overhead.

### 9. Variations and Alternative Embodiments

The server may use different model architectures, such as recurrent neural networks or hybrid architectures, provided that the model can receive model input data and generate text data in natural language. The evaluation model may be integrated with the generative AI model as a multi-task network or may be implemented as a separate service. The feedback data may include additional fields such as stylistic category, sentiment polarity, or estimated reading level, and input guide information may recommend changes in vocabulary, tone, or structure. The server may implement different types of machine learning processing for updating generation conditions, such as:
supervised learning that maps contextual features to optimal decoding parameters,
reinforcement learning that treats improvements in evaluation scores as rewards, or
unsupervised clustering of interaction sets to identify patterns of usage and adapt guide messages accordingly.

The terminal may include additional modalities such as speech input, where the terminal converts speech to text before transmitting prompt sentences to the server. The display of generated text and feedback may also include audio output or haptic signals to enhance accessibility.

Through these embodiments and variations, the server, the terminal, and the user cooperate to realize the claimed system, in which structured handling of prompt sentences, generative AI model input, feedback data, and interaction sets yields an improvement in the operation of computer systems and the efficient use of generative AI models, rather than merely automating human writing tasks.

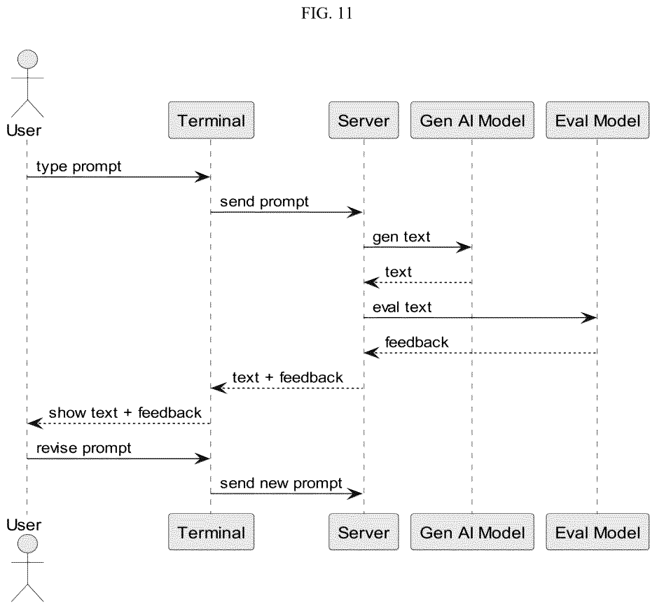

The following describes the processing flow using FIG. 11.

### Step 1:

The user activates the application on the terminal and prepares an input screen.

The terminal displays an input field for a prompt sentence, areas for generated text and feedback, and a control such as a “Generate” button.

Input: No user text yet; initial UI state.

Output: A visible interface that can accept a prompt sentence and later display generated text and feedback.

### Step 2:

The user enters a prompt sentence on the terminal.

The user operates a keyboard or touch interface to input feelings or thoughts in natural language, for example, “I feel very happy today.” or “I am anxious about starting a new job tomorrow.”

The terminal captures each character input, updates the text field, and stores the string in working memory.

Input: Keystroke events and UI focus state.

Output: A complete prompt sentence string stored in the terminal, ready to be transmitted to the server.

### Step 3:

The terminal validates and packages the prompt sentence.

The terminal checks that the prompt sentence is not empty and that its length is within a predefined limit. The terminal may trim leading and trailing whitespace and normalize the character encoding.

The terminal then constructs a data structure including at least the prompt sentence and optional metadata such as language and client identifier.

Input: Prompt sentence string from the user.

Output: A structured request object containing the prompt sentence, suitable for network transmission.

### Step 4:

The terminal sends the packaged prompt sentence to the server.

The terminal uses a communication stack to serialize the structured request object into a message, attach protocol headers, and transmit the message over a network connection to a designated server endpoint. The terminal may start an asynchronous network call and temporarily disable the “Generate” button.

Input: Structured request object with the prompt sentence.

Output: A network message delivered to the server and a local pending-request state on the terminal.

### Step 5:

The server receives and parses the request containing the prompt sentence.

The server accepts the network connection, decodes the message, and parses the structured data. The server extracts the prompt sentence string and associated metadata, then stores them in memory as internal variables or records.

Input: Network message from the terminal including the structured request.

Output: An internal representation of the prompt sentence and associated metadata on the server.

### Step 6:

The server generates structured data representing the prompt sentence.

The server associates the raw prompt sentence string with additional fields such as language code, timestamp, user/session identifiers, and content type. The server may also compute basic features, such as length or an estimated sentiment score, and add them to the structured data.

The server stores this structured data in working memory or in a database.

Input: Raw prompt sentence string and parsed metadata.

Output: A structured prompt object that can be used for model input generation and later correlation with generated text and feedback.

### Step 7:

The server constructs model input data for the generative AI model.

The server combines a task description and context with the prompt sentence to create a single model input text, such as:

“You are a writing assistant that helps a user express feelings. Expand the following feeling into a detailed and natural paragraph: ‘I feel very happy today.’”

The server then converts this combined text into tokens using a tokenizer associated with the generative AI model, producing an array of token identifiers. The server attaches control parameters such as maximum token count and decoding parameters.

Input: Structured prompt object containing the user's prompt sentence.

Output: Model input data including token identifiers and control parameters, ready for inference.

### Step 8:

The server invokes the generative AI model to generate text data.

The server passes the model input data to a generative AI model execution environment. The generative AI model performs numerical computations, including embedding lookup, matrix multiplications, self-attention calculations, and activation functions across multiple layers, to estimate probability distributions over next tokens and select a sequence of output tokens. The server receives the sequence of output tokens and converts them back into a natural language string, which forms the generated text.

Input: Tokenized model input data and control parameters.

Output: Generated text data that elaborates the user's feelings or thoughts.

### Step 9:

The server structures and stores the generated text data.

The server creates a generated text object that includes the generated text string, model identifier, decoding parameters, and a link to the corresponding structured prompt object. The server may store this object in memory and optionally in a database for later analysis.

Input: Generated text string and internal generation metadata.

Output: A structured generated text object associated with the original prompt sentence.

### Step 10:

The server prepares evaluation input for feedback generation.

The server combines the original prompt sentence and the generated text into an evaluation input text, such as:
“Original feeling: ‘I feel very happy today.’
Generated paragraph: ‘Today has been a wonderful day. I spent joyful moments with my friends, and my heart feels truly fulfilled.’
Evaluate clarity, emotional depth, concreteness, and structure, and provide improvement suggestions.”

The server tokenizes this evaluation input and attaches evaluation-specific control parameters.

Input: Structured prompt object and structured generated text object.

Output: Evaluation model input data, including token identifiers and evaluation instructions.

### Step 11:

The server generates feedback data using an evaluation model.

The server passes the evaluation input data to a generative AI model or a dedicated evaluation model. The model processes the token sequence, computes internal representations, and outputs both suggested scores or qualitative assessments and textual suggestions.

The server parses the model output and maps parts of the output to structured fields such as clarity score, emotional depth score, and suggestions text describing concrete improvement points.

Input: Tokenized evaluation input data.

Output: Structured feedback data that includes evaluation information and specific improvement points.

### Step 12:

The server generates input guide information based on the feedback data.

The server examines feedback attributes, such as low concreteness or insufficient emotional depth, and applies predetermined rules or learned mappings to create guide messages for the next user input. For example, if concreteness is low, the server may generate the message “Please add at least one specific episode that explains why you feel this way.”

Input: Structured feedback data.

Output: Input guide information that instructs the user on how to improve subsequent prompt sentences.

### Step 13:

The server assembles a response for the terminal.

The server creates a response object that includes the generated text data, the feedback data, and, when applicable, the input guide information. The server serializes this object into a message and prepares it for network transmission to the terminal.

Input: Structured generated text object, structured feedback data, and input guide information.

Output: A response message containing generated text, feedback, and guidance.

### Step 14:

The server transmits the response to the terminal.

The server sends the serialized response message through its network interface to the communication endpoint associated with the terminal. The server may log transmission status for reliability monitoring.

Input: Response message prepared by the server.

Output: A delivered network message carrying generated text, feedback, and input guide information to the terminal.

### Step 15:

The terminal receives and parses the response from the server.

The terminal accepts the incoming network message, decodes it, and parses the structured content. The terminal extracts the generated text, feedback data, and input guide information, and stores them in local memory structures. The terminal then clears any loading indicators previously displayed.

Input: Response message from the server.

Output: Local variables or objects containing generated text, feedback, and guide information on the terminal.

### Step 16:

The terminal displays the generated text, feedback, and input guide information.

The terminal renders the generated text in a display area labeled, for example, “Generated Text,” renders the feedback in an area labeled “Feedback,” and optionally renders the input guide information near the prompt input field. The terminal may format feedback as bullet points or separate sentences for clarity.

Input: Generated text string, feedback data, and input guide information.

Output: A visual presentation that allows the user to read the generated text, understand the feedback, and see guidance for the next input.

### Step 17:

The user reviews the generated text and feedback and decides on revisions.

The user reads the generated text, considers the feedback, and refers to the input guide information. Based on this information, the user determines how to modify or extend the expression, for example by adding specific events or emotional details as suggested.

Input: Displayed generated text, feedback, and guide messages.

Output: A mental revision plan that the user will apply when entering new or revised text.

### Step 18:

The user inputs revised text on the terminal as a new prompt sentence.

The user edits or rewrites text in an input field, for example changing “I feel very happy today.” to “Today has been a wonderful day. I went to the park with my closest friends, and we laughed together for hours.”

The terminal captures the revised text and treats it as a new prompt sentence.

Input: Keystrokes and edit operations performed by the user.

Output: A new or revised prompt sentence stored on the terminal, ready for another cycle of processing.

### Step 19:

The terminal initiates another interaction cycle with the server using the revised prompt sentence.

The terminal repeats validation and packaging for the revised prompt sentence and sends a new request to the server. The server then processes this new prompt sentence in the same manner as before, but may apply updated generation conditions that were learned from previously stored interaction sets.

Input: Revised prompt sentence from the user.

Output: A new request to the server, starting another iteration of generation and feedback, thereby enabling progressive refinement of the user's text and more efficient operation of the system.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional text support systems that assist users in expressing emotions typically rely on fixed templates or shallow sentiment tags. Such systems often perform only coarse-grained sentiment analysis (for example, positive/negative/neutral classification) and then apply static rules to generate or suggest text. As a result, these systems fail to leverage detailed emotional state information as a computational resource within the text generation pipeline, and they do not structurally integrate user interaction data, such as edits and self-evaluations, back into the processing flow. This leads to several technical problems in the field of computer-based natural language processing.

First, existing emotion-aware text generation architectures generally do not convert user input text into structured emotion representations that are tightly coupled with subsequent generative model conditioning. Emotion type and intensity, when computed, are usually not represented as normalized numerical data that can be systematically combined with contextual information and generation policies into a prompt sentence for a generative AI model. Consequently, the generative AI model is under-specified with respect to the user's emotional intent, which degrades controllability and consistency of the generated natural language text and increases the computational overhead for repeated trial-and-error requests. Second, many systems treat a generative AI model as a black box that only returns a draft text, without performing a structured, machine-executed analysis of the generated text itself. The systems typically do not perform an automatic evaluation of sentence structure, concreteness of emotional expression, presence or absence of event description, and presence or absence of sensory description. Because there is no machine-level feedback loop that decomposes the generated text into evaluable elements and produces targeted improvement proposals, the system cannot effectively guide the user's editing operations. This results in inefficient use of computing resources, such as repeated full regenerations of text, and prevents the system from systematically improving the quality of user-generated content. Third, conventional systems do not track and utilize emotion changes over time as a structured signal within the text generation and feedback pipeline. They do not compute temporal patterns of emotion intensity from multiple user inputs and do not dynamically adjust prompts and feedback content on the basis of such patterns. This lack of temporal modeling causes the system to provide context-insensitive prompts and feedback, which in turn reduces the technical effect of personalized and adaptive text generation.

Fourth, when user-generated text is to be distributed via external content distribution services, existing systems rely heavily on manual adjustment of format, style, and length. There is no technical mechanism that optimizes prompt sentences to encode constraints regarding content length, writing style, output format, and target audience in a form that generative AI models can consume. Accordingly, the systems cannot automatically generate texts that are computationally aligned with heterogeneous distribution requirements, thereby increasing integration complexity and processing latency.

Fifth, user edits and self-evaluation behavior are typically not captured as structured data tied back to the original emotional analysis and generation parameters. Without storing and associating editing operation content as a self-evaluation history, the system cannot analyze which feedback was effective, nor can it refine subsequent processing steps such as prompt construction or feedback generation. This limits the capacity of the system to adapt over time and prevents architectural improvements in model control and human-computer interaction. In view of the foregoing, there is a need for a computer-implemented system that (i) converts user emotion-related text into structured numerical emotion data, (ii) constructs rich prompt sentences that condition a generative AI model on emotion type, intensity, event context, and output policy, (iii) automatically analyzes generated text and produces machine-generated, fine-grained feedback, (iv) dynamically adapts prompt and feedback content based on temporal emotion patterns, and (v) records user editing operations as a self-evaluation history linked to the underlying data pipeline. Such a system should improve the technical functioning of servers executing natural language processing by enhancing controllability, adaptability, and efficiency in emotion-aware text generation and editing support.

The specific processing by the specific processing unit 290 of the data processing device 12 in Application Example 1 is realized by the following means.

The present invention provides a server comprising a processor configured to receive character information relating to a user's emotion or thought from a terminal, convert the character information into structured data by executing, by the processor, preprocessing including at least tokenization, segmentation, normalization, and vocabulary transformation, and input the structured data into a trained machine learning model to compute, as numerical data, a type of emotion and an intensity of the emotion; a processor further configured to generate, based on the numerical data and the character information, a prompt sentence including at least the type of emotion, the intensity of the emotion, an outline of an event, and an expression policy, and to transmit, via a communication network, request data including the prompt sentence as input data to an external generative AI model so as to cause the external generative AI model to generate natural language text reflecting the user's emotion; a processor further configured to receive the natural language text from the external generative AI model, analyze the natural language text by evaluating, according to machine-executable evaluation criteria, at least a sentence structure, a concreteness of emotional expressions, a presence or absence of event description, and a presence or absence of sensory description, and to generate, based on a result of the analysis, feedback information including improvement proposals indicating additional description portions and modification policies for user editing of the natural language text; a processor further configured to output the feedback information to the terminal and to receive, from the terminal, editing operation content applied by the user to at least one of the natural language text and the feedback information, and to store the editing operation content in association with the character information and the numerical data as self-evaluation history data of the user; and, in some embodiments, a processor further configured to calculate, for a plurality of pieces of character information input from the user in a time series, emotion type and emotion intensity as numerical data for each of the pieces, compute a temporal change pattern of the numerical data, and dynamically modify at least one of content of the prompt sentence and content of the feedback information on the basis of the temporal change pattern, and, in further embodiments, to acquire usage information indicating that the natural language text is to be provided as user-generated content in an external content distribution service and to include, in the prompt sentence, conditions regarding at least one of content length, writing style, output format, and target audience so as to optimize the input data for the external generative AI model. This enables a computer system to more effectively control a generative AI model using structured emotion data, to automatically generate targeted feedback for improving user text, to adapt prompting and feedback based on temporal emotion changes and distribution requirements, and to leverage user editing behavior as structured self-evaluation history, thereby improving the technical performance, adaptability, and efficiency of emotion-aware natural language processing on the server.

The term “processor” refers to a hardware information processing unit, or a combination of hardware resources, configured to execute instructions of a program, and includes, for example, a central processing unit, a graphics processing unit, a digital signal processor, or a plurality of such units operating cooperatively.

The term “character information” refers to digital data representing symbols, letters, or other textual elements that express a user's emotions, thoughts, or related content, and includes at least text strings encoded in a character encoding scheme.

The term “user's emotion or thought” refers to a mental state of a person, including one or more types of affective conditions such as joy, sadness, anger, fear, or neutrality, and subjective ideas or intentions associated with such affective conditions.

The term “structured data” refers to data that has been organized into a defined format suitable for machine processing, such as a sequence of tokens, vectors, indices, or records, such that each element is associated with a specific attribute or position.

The term “preprocessing” refers to a series of computational operations applied to character information before machine learning or further analysis, and includes, for example, tokenization, segmentation, normalization, and transformation into a standardized representation.

The term “tokenization” refers to a process of computationally dividing character information into smaller units, such as words, subwords, or symbols, in order to generate discrete elements that can be individually processed.

The term “segmentation” refers to a process of partitioning character information into logical units, such as sentences, clauses, or phrases, by detecting boundaries based on punctuation, grammar, or other indicators.

The term “normalization” refers to a process of converting character information into a standardized form by operations such as lowercasing, removing or unifying whitespace, or replacing variant forms of equivalent terms, to reduce variability that is irrelevant to later processing.

The term “vocabulary transformation” refers to a process of mapping tokens contained in character information to elements of a pre-defined vocabulary, such as integer indices or embedding vectors, for use as input to a machine learning model.

The term “machine learning model” refers to a computational model trained using data to perform tasks such as classification, regression, or generation, and includes, for example, a neural network model, a probabilistic model, or an ensemble of such models.

The term “numerical data” refers to data expressed as one or more numeric values, such as scalars, vectors, matrices, or tensors, that quantitatively represent attributes including emotion type probabilities and emotion intensity scores.

The term “type of emotion” refers to a categorical representation of an emotion class, such as joy, sadness, anger, fear, surprise, or neutrality, determined by a machine learning model from character information.

The term “intensity of the emotion” refers to a quantitative value indicating a strength or degree of an emotion, for example represented as a continuous score or a discrete level computed by a machine learning model.

The term “prompt sentence” refers to a text string or sequence of tokens constructed to condition or guide a generative AI model, and including specific information such as emotion type, emotion intensity, event outline, and expression policy.

The term “expression policy” refers to one or more constraints or preferences specifying how a generative AI model should express content, including aspects such as tone, level of detail, perspective, politeness, or style.

The term “outline of an event” refers to a concise textual description of a situation, occurrence, or context related to the user's emotion, which is included in a prompt sentence to inform the generative AI model.

The term “request data” refers to electronic data transmitted to a generative AI model, including at least a prompt sentence and optionally additional parameters such as output length, style constraints, and randomness control values.

The term “generative AI model” refers to a machine learning model configured to generate sequences of symbols, including natural language text, in response to input data such as a prompt sentence, and includes, for example, an autoregressive language model or a sequence-to-sequence model.

The term “natural language text” refers to a sequence of characters or tokens that form grammatical and semantically interpretable expressions in a human language.

The term “communication network” refers to a wired or wireless infrastructure enabling data transmission between devices, including at least packet-switched networks such as local area networks and wide area networks.

The term “evaluation criteria” refers to predefined, machine-executable rules or metrics used to analyze natural language text, including aspects such as sentence structure, concreteness of emotional expressions, presence or absence of event description, and presence or absence of sensory description.

The term “sentence structure” refers to an arrangement of words and phrases in a sentence, including grammatical correctness, clause organization, and punctuation patterns, which can be analyzed by a program.

The term “concreteness of emotional expressions” refers to a degree to which emotional content in text is specified with particular details, such as explicit feelings, causes, or examples, as opposed to vague or generic statements.

The term “event description” refers to text segments that describe actions, occurrences, or situations associated with a user's emotion, including who did what, when, where, and under what conditions.

The term “sensory description” refers to text segments that express perceptions through senses, such as visual, auditory, tactile, olfactory, or gustatory impressions, in relation to an emotional experience.

The term “feedback information” refers to data generated by the processor that provides guidance or suggestions to a user for improving a natural language text, and includes one or more improvement proposals.

The term “improvement proposals” refers to instructions, hints, or recommendations that indicate specific parts of a natural language text to be modified or expanded and provide a direction for such modification or expansion.

The term “additional description portions” refers to positions or contexts in a natural language text where further content is recommended to be added to enhance clarity, concreteness, or emotional expressiveness.

The term “modification policies” refers to guidelines describing how a user should change or refine a natural language text, such as by adding detail, adjusting tone, or clarifying emotional context.

The term “terminal” or “terminal apparatus” refers to an information processing device used by a user to input character information and receive outputs, and includes devices such as smartphones, tablet computers, and personal computers.

The term “editing operation content” refers to data representing operations performed by a user to modify a natural language text or feedback information, including insertions, deletions, replacements, and reordering of text segments.

The term “self-evaluation history” refers to stored data that associates editing operation content with corresponding character information and numerical emotion data, representing how a user has evaluated and revised text over time.

The term “time series” refers to an ordered sequence of data points indexed by time, such as a series of character information items input by a user at different times.

The term “temporal change amount” refers to a quantitative difference between numerical data values, such as emotion intensity scores, at different time points.

The term “emotion change pattern” refers to a representation of how emotion type or emotion intensity evolves over time, derived from temporal change amounts of numerical data.

The term “dynamic modification” refers to a process of altering at least one of the content of a prompt sentence or the content of feedback information during operation based on current or updated data such as an emotion change pattern.

The term “usage information” refers to data indicating how generated natural language text is intended to be used, including whether it is to be provided as user-generated content in an external content distribution service.

The term “user-generated content” refers to content created or finalized by a user, possibly with system assistance, and intended for publication or sharing through a distribution platform or service.

The term “content distribution service” refers to a system or platform that delivers digital content to multiple recipients or audience members, including services for publishing text, images, or other media.

The term “content length” refers to a measure of size of natural language text, such as the number of characters, words, tokens, or sentences.

The term “writing style” refers to a characteristic manner of textual expression, including formality level, narrative perspective, and rhetorical tone.

The term “output format” refers to a structural specification of generated data, including layout, sectioning, markup, or file type requirements applied to natural language text.

The term “target audience” refers to an intended group of readers or viewers for generated content, characterized by attributes such as age group, expertise level, or interest domain.

The term “input data to the generative AI model” refers to data supplied to a generative AI model to cause it to produce output, including at least a prompt sentence and optionally configuration parameters and conditioning information.

In one embodiment, a server cooperates with one or more terminals operated by users to implement emotion-aware natural language generation and feedback. The server includes at least one processor, a memory storing program instructions and data structures, and a network interface. The terminal includes an input/output interface, a display device, and a communication module configured to exchange data with the server over a communication network.

The server stores and executes a program that implements multiple software modules, including an input management module, a preprocessing module, an emotion analysis module, a prompt construction module, a generative AI interface module, a generated-text analysis module, a feedback generation module, a user-edit logging module, and a data storage module. The server uses a general-purpose operating system, such as a server-class operating system, and an application framework, such as a web application framework implemented in a programming language such as Python. In one example, the server uses a framework such as Django or Flask for HTTP request handling, a numerical computation library such as NumPy, and a machine learning library such as TensorFlow for neural network computation. The server may communicate with an external generative AI model over HTTPS using an HTTP client library, such as the “requests” library or an official SDK. The terminal executes an application that may be implemented as a web application using HTML, CSS, and JavaScript in a browser such as Google Chrome, or as a native mobile application using frameworks such as SwiftUI on a smartphone or a comparable user interface framework on another device. The terminal presents a text input area, graphical controls, and a display area for generated text and feedback.

The user operates the terminal to input character information relating to emotions or thoughts, for example, a sentence such as “I feel very happy today because our project went well.” The terminal converts keystrokes or touch input into a text string encoded as digital character information. The terminal may perform local validation, such as checking that the input is not empty and does not exceed a predetermined length, and then transmits the character information to the server via a secure communication protocol.

The server receives the character information and stores it in the memory. The server executes the preprocessing module to transform the raw character information into a structured representation suitable for neural network processing. In one embodiment, the server applies tokenization using a natural language processing library such as spaCy or NLTK. The server then applies normalization, for example converting all characters to lowercase, removing extraneous whitespace, standardizing punctuation, and mapping certain synonymous expressions to canonical forms. The server applies vocabulary transformation by mapping each token to an integer index that references an entry in a vocabulary table stored in memory. The server pads or truncates the resulting index sequence to a fixed length, such as 128 or 256 tokens, thereby forming an input vector of predetermined dimensionality. This fixed-size vector can be efficiently processed on modern hardware and enables batch processing of multiple user inputs.

The server executes the emotion analysis module implemented using TensorFlow. In one embodiment, the emotion analysis model is a neural network including an embedding layer, one or more recurrent or transformer-based layers, and a fully connected output layer. The embedding layer maps each vocabulary index to a dense vector of real-valued features, for example of dimension 256. A recurrent layer may be implemented as a bi-directional long short-term memory (LSTM) layer, or a transformer encoder block that applies multi-head self-attention and feed-forward sub-layers. The output layer produces a probability distribution over predefined emotion categories, such as joy, sadness, anger, fear, and neutral, and may also output a continuous emotion intensity score. The server loads model parameters, which were determined during a prior training phase, from persistent storage into memory.

During inference, the server causes TensorFlow to perform a series of numerical operations, including matrix multiplications, non-linear activations, and softmax operations. The server obtains, for example, probabilities for each emotion category and selects the category with the highest probability as the primary emotion. The server may also derive an emotion intensity value from the maximum probability or from a separate regression head of the network. As a result, the server converts unstructured character information into structured numerical data representing the type of emotion and the intensity of the emotion. This conversion enables later modules to use precise numerical signals rather than coarse labels, improving control over generation.

The server executes the prompt construction module to generate a prompt sentence that instructs a generative AI model how to produce text. The server combines at least (i) the primary emotion label, (ii) the emotion intensity, (iii) the original character information, and (iv) one or more expression policies into a coherent natural language description. The server may encode the emotion intensity by mapping numerical ranges to qualitative descriptors such as “low,” “moderate,” and “very high.” In one example, when the server detects that the primary emotion is joy with high intensity, the server constructs a prompt sentence such as: “User emotion: joy (intensity: very high). Original text: ‘I feel very happy today because our project went well.’ Please generate a detailed and natural English paragraph that expresses this joy, explains what happened in the project, and shows how the user felt during the success.”

In another example, when the server detects sadness, the server constructs a prompt sentence such as:
“User emotion: sadness (intensity: medium). Original text: ‘I feel lonely because my close friend moved away.’ Please write a reflective paragraph that gently expresses this sadness and describes the value of the friendship.”

The server thereby uses a structured algorithm to create prompt sentences that encode not only the user's textual input but also numerical emotion information and explicit output policies. This structure allows the generative AI model to produce outputs that are more aligned with the user's emotional state and context, and reduces the number of iterations required to obtain satisfactory results.

The server executes a generative AI interface module to transmit the prompt sentence to a generative AI model. In one embodiment, the generative AI model is located on an external computing system accessible through an application programming interface. The server forms request data that includes the prompt sentence, a model identifier, and generation parameters such as maximum output length and sampling temperature. The server then sends an HTTPS request containing the request data to the external system. The external system executes an autoregressive language model, for example a transformer-based model with multiple self-attention layers, to produce natural language text in response to the prompt sentence. The external system returns generated text, which the server receives and stores in memory.

The server executes the generated-text analysis module to analyze the received natural language text. The server performs sentence segmentation, for example using a statistical or rule-based sentence boundary detector. The server computes metrics such as the number of sentences, average sentence length, and the presence of emotion-related keywords associated with the identified emotion category. The server applies evaluation criteria, including sentence structure, concreteness of emotional expressions, presence or absence of explicit event descriptions, and presence or absence of sensory details. In one embodiment, the server maintains a lexicon of emotion terms and sensory descriptors, and performs pattern matching to detect whether these elements are present. The server may also invoke a secondary classifier or scoring function, implemented in TensorFlow or with another algorithm, to rate the vividness and specificity of the emotional description.

In some embodiments, the server constructs a secondary prompt sentence to obtain improvement proposals from the generative AI model. For example, the server may send:
“Text: ‘Today was an incredibly joyful day. Our project finally came together, and the results were better than we expected. When we saw the final presentation run smoothly, everyone on the team smiled and congratulated each other. I felt proud, relieved, and genuinely grateful for all the effort we shared.’ Please list 2-3 concrete suggestions to make this text express the user's joy more vividly and specifically.”

The generative AI model then returns suggestions, such as “Add more detail about what exactly made the project successful” or “Describe physical sensations or body reactions that accompanied the joy.” The server parses these suggestions and combines them with rule-based findings to form feedback information. By decomposing the output into a set of evaluable dimensions and producing targeted improvement proposals, the server reduces the need for complete re-generation of entire texts and improves computational efficiency.

The server executes the feedback generation module to assemble feedback information in a structured manner. The feedback information includes improvement proposals that specify additional description portions, such as “add more detail after the sentence describing the client's reaction,” and modification policies, such as “clarify how the user physically felt during the event.” The server outputs the feedback information, together with the generated text, to the terminal through the network interface.

The terminal receives the generated text and feedback information and displays them to the user. The terminal may present the generated text in a read-only region and list feedback items as bullets or numbered suggestions. In some embodiments, the terminal highlights portions of the text to which particular feedback items apply, thereby guiding the user to specific segments that may benefit from revision.

The user inspects the generated text and feedback and performs editing operations on the terminal. The user may insert additional sentences, delete redundant expressions, or modify phrases to more accurately reflect personal feelings. The terminal records the editing operations in detail, such as which characters or tokens were added, removed, or replaced, and the positions of these changes in the text.

The terminal transmits the editing operation content to the server. The server executes the user-edit logging module to store the editing operation content in association with the original character information, the emotion analysis results, and the generated text. The server thereby creates a self-evaluation history that reflects how the user responded to feedback and how the user transformed the generated text. Over time, this self-evaluation history can be used to calibrate future feedback or to analyze which kinds of feedback are most effective for particular users or emotion patterns.

In another embodiment, the server computes emotion change patterns over time. The server stores multiple instances of character information input by the same user, together with their corresponding emotion type and intensity values. The server computes temporal differences in intensity values, such as increases or decreases between consecutive entries, and may apply time-series analysis methods, such as calculating moving averages or detecting threshold-crossing events. When the server detects that a user's emotional intensity is consistently increasing or decreasing, the server dynamically modifies the content of subsequent prompt sentences and feedback information. For example, if the server detects that a user's sadness has been gradually increasing, the server can adjust prompt sentences to encourage more reflective and supportive wording and can reduce the complexity of requested narrative structure, thereby easing the cognitive burden. This dynamic adaptation improves the technical behavior of the system by reducing unnecessary generation complexity, minimizing back-and-forth requests, and personalizing the generation process based on structured temporal data.

In yet another embodiment, the server optimizes prompt sentences for external content distribution. When the server obtains usage information indicating that a generated text is intended for publication as user-generated content on a particular content distribution service, the server incorporates constraints such as length limits, preferred writing style, output format, and target audience characteristics into the prompt sentence. For example, when a platform requires concise posts, the server can construct a prompt such as:
“User emotion: joy (intensity: high). Original text: ‘I feel very happy today because our project went well.’ Usage: short social media post for general audience. Please generate a concise and friendly English message (within 100 words) that expresses this joy and briefly mentions the project's success.”

By embedding distribution-specific conditions in the prompt sentence before invoking the generative AI model, the server reduces the need for post-processing transformations, minimizes truncation errors, and ensures that the generated content is more likely to meet platform constraints on the first attempt. This reduces communication overhead, computing time, and storage of failed or discarded versions.

From a technical perspective, the server improves computer technology in several ways. The transformation of free-form character information into structured numerical emotion data, followed by controlled prompt sentence construction, defines a concrete data flow and model-control mechanism that enhances the controllability and predictability of generative outputs. The combination of rule-based analysis and model-based suggestions for feedback generation creates a closed-loop system in which generated text is machine-evaluated and selectively refined, rather than regenerated from scratch. This reduces computational load on the generative AI model, decreases network traffic, and improves latency.

Furthermore, by logging user editing operations as self-evaluation history tied to original inputs and analysis data, the server establishes a data structure that is not present in conventional systems. This history can be mined to adjust future emotion classification thresholds, refine prompt templates, and identify effective feedback patterns. As a result, the system continuously improves its own performance when deployed over time, which is a technical enhancement of the overall natural language processing pipeline.

The use of specific neural network architectures, such as embedding layers and transformer or recurrent layers for emotion analysis, and the explicit specification of input vector structures, enable efficient use of modern hardware accelerators. The system can batch multiple emotion analyses and generative requests, share embedding tables, and reuse cached representations to reduce redundant computation. These implementation details yield improvements in processing throughput and resource utilization compared to ad hoc or purely manual methods of text editing and emotional expression.

The server processes emotional information using algorithmic rules and numerical thresholds that differ from human intuition-based editing. For example, the server may apply a rule that if a generated paragraph contains fewer than a specified number of sensory descriptors relative to its length, the feedback must contain at least one suggestion to add sensory detail. Another rule may require that any text classified as high-intensity emotion must mention at least one cause or event linked to that emotion. Such non-human, deterministic constraints, implemented as part of the feedback generation module, enable consistent and repeatable enhancements in text quality that do not depend on human editorial judgment.

In alternative embodiments, the server may employ different machine learning models for emotion analysis, such as convolutional neural networks or hybrid architectures combining recurrent layers with attention mechanisms. The server may train these models using supervised learning on labeled datasets that associate text with emotion categories and intensities. During training, the server minimizes a loss function, such as cross-entropy for classification and mean squared error for intensity regression, using an optimization algorithm such as stochastic gradient descent with momentum or an adaptive learning rate method. The server may apply data augmentation techniques such as synonym replacement, back-translation, or noise injection to improve robustness. These training details ensure that the deployed models achieve high accuracy and generalize to diverse user inputs, thereby reducing misclassification and enhancing downstream generation quality.

In further embodiments, the server can integrate additional modules for language adaptation, such as translation or style transfer, implemented using neural sequence-to-sequence models. The server may insert such modules between the generative AI model and the feedback generation module to convert generated text into a different language or style while preserving the emotion structure and event content defined by the emotion analysis and prompt construction modules.

As described, the server, the terminal, and the user cooperate to implement embodiments of the invention. The server performs concrete technical operations on digital data structures using specified algorithms and models. The terminal converts user actions into data and presents processed content and feedback. The user interacts with the system to produce final texts, while the underlying computing infrastructure, enhanced by the described modules and data flows, provides improved processing speed, accuracy, and efficiency in emotion-aware natural language generation and editing.

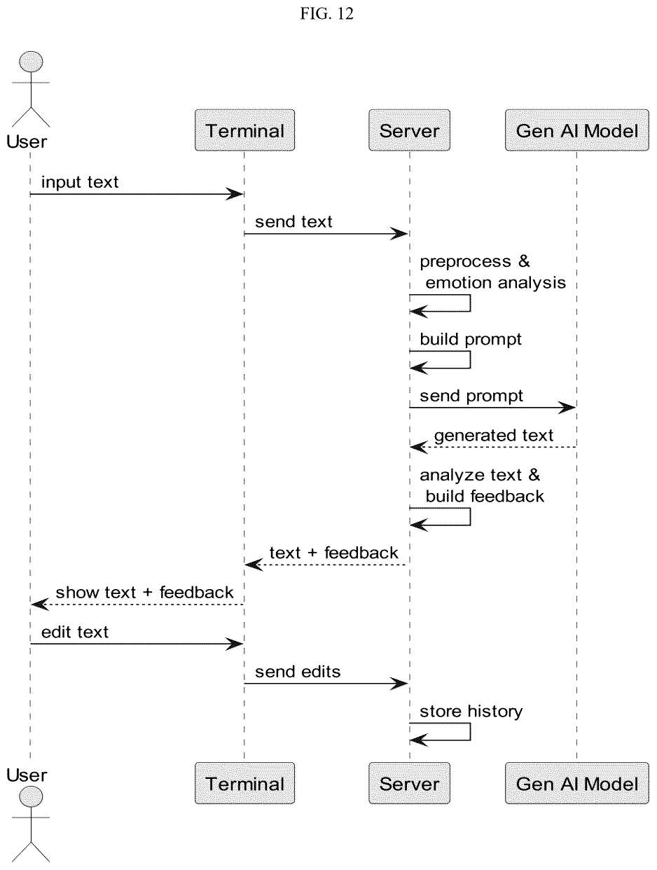

The following describes the processing flow using FIG. 12.

### Step 1:

The user operates the terminal to input character information relating to an emotion or thought.

The terminal displays an input screen with a text field and receives keystrokes or touch input from the user.

Input: raw user keystrokes or touch events.

Processing: the terminal converts the input events into a text string encoded in a character set (for example, UTF-8), checks that the length is within a preset limit, and ensures that the string is not empty.

Output: validated character information such as “I feel very happy today because our project went well.”

### Step 2:

The terminal transmits the validated character information to the server.

The terminal constructs a request payload including at least the character information and a user identifier and sends it to the server via an HTTPS connection.

Input: validated character information and user identifier stored in the terminal.

Processing: the terminal encapsulates the data into a message, sets HTTP headers (for example, content type and authentication information), and uses a communication module to send the message to a predefined server endpoint.

Output: a network request containing the character information arriving at the server.

### Step 3:

The server receives the character information and stores it temporarily in memory.

The server parses the incoming request, extracts the character information, and writes a log entry with a timestamp.

Input: network request containing the character information and user identifier.

Processing: the server decodes the request body, verifies the data format, and allocates memory buffers to hold the text and associated metadata.

Output: in-memory representation of the character information and metadata, ready for preprocessing.

### Step 4:

The server executes a preprocessing operation on the character information to generate structured data.

The server applies tokenization, normalization, segmentation, and vocabulary transformation using a natural language processing library.

Input: raw character information stored in memory.

Processing: the server splits the text into tokens (words and punctuation), converts tokens to lowercase, removes or standardizes extra whitespace, detects sentence boundaries, and maps each token to a vocabulary index. The server pads or truncates the index sequence to a fixed length and arranges it into a numerical vector suitable for neural network input.

Output: a fixed-length numerical vector or tensor representing the preprocessed text.

### Step 5:

The server performs emotion analysis using a machine learning model implemented on a neural network framework.

The server passes the numerical vector through an embedding layer, intermediate layers (for example, LSTM or transformer layers), and an output layer to obtain emotion probabilities and intensity.

Input: numerical tensor representing the preprocessed character information.

Processing: the server loads trained model weights, executes matrix multiplications and non-linear activation functions, applies softmax to obtain a probability distribution over emotion classes, and, if applicable, computes a continuous intensity value from a regression output. The server then selects the emotion with the highest probability and pairs it with the intensity score.

Output: structured emotion data including a primary emotion label (for example, “joy”) and a numerical intensity value (for example, 0.91).

### Step 6:

The server constructs a prompt sentence for a generative AI model based on the emotion data and the original character information.

The server combines the primary emotion, the intensity, and relevant parts of the user's text with predefined expression policies.

Input: original character information and structured emotion data (emotion label and intensity).

Processing: the server maps the intensity value to a qualitative descriptor (for example, “very high”), inserts the emotion description, the original text, and requested style and length instructions into a textual template, and generates a coherent instruction sentence.

Output: a prompt sentence such as “User emotion: joy (intensity: very high). Original text: ‘I feel very happy today because our project went well.’ Please generate a detailed and natural English paragraph that expresses this joy, explains what happened in the project, and shows how the user felt during the success.”

### Step 7:

The server sends the prompt sentence to a generative AI model and obtains generated natural language text.

The server creates a request including the prompt sentence and generation parameters and transmits it to the generative AI model over a communication network.

Input: prompt sentence and configuration parameters (such as maximum output length and temperature).

Processing: the server formats the data into a request, sends it via HTTPS, and waits for a response. The generative AI model processes the prompt and returns generated text. The server receives the response, extracts the generated text, and stores it in memory.

Output: generated natural language text reflecting the user's emotion, for example, a multi-sentence paragraph about the successful project and the user's happiness.

### Step 8:

The server analyzes the generated natural language text using rule-based and model-based criteria.

The server evaluates sentence structure, concreteness of emotional expressions, presence or absence of event descriptions, and presence or absence of sensory details.

Input: generated natural language text returned by the generative AI model.

Processing: the server segments the text into sentences, measures sentence length and count, searches for emotion-related keywords and sensory terms, and applies scoring rules. The server may also call an additional classifier to rate vividness and specificity.

Output: analysis results indicating strengths and weaknesses of the generated text along defined dimensions.

### Step 9:

The server generates feedback information containing improvement proposals based on the analysis results.

The server converts detected weaknesses into explicit suggestions and localizes where in the text the user should consider revising.

Input: analysis results describing structural and semantic properties of the generated text.

Processing: the server applies mapping rules that associate certain patterns (for example, lack of sensory descriptors, absence of explicit cause of emotion) with specific feedback messages. The server compiles these messages into a list of improvement proposals and, if applicable, references positions or sentences to which the proposals apply.

Output: feedback information including improvement proposals, such as “Add more detail about what exactly made the project successful” and “Describe physical sensations or body reactions that accompanied the joy.”

### Step 10:

The server sends the generated text and feedback information to the terminal.

The server packages both elements into a response and transmits the response over the network.

Input: generated natural language text and feedback information stored on the server.

Processing: the server encodes the data in a response format, sets appropriate headers, and sends it via the network interface to the terminal associated with the user.

Output: a network response received by the terminal containing the generated text and corresponding feedback information.

### Step 11:

The terminal displays the generated text and feedback information to the user.

The terminal renders the text in a readable layout, separating the main paragraph from the list of suggestions.

Input: response data including the generated text and feedback information.

Processing: the terminal parses the response, stores the text and feedback temporarily, and draws them on the display device using its user interface components. The terminal may visually emphasize parts of the generated text linked to particular feedback items.

Output: a visual presentation on the terminal screen that the user can read and interact with.

### Step 12:

The user reviews the generated text and feedback and performs editing operations on the terminal.

The user modifies the text to better reflect personal feelings, guided by the feedback suggestions.

Input: displayed generated text and feedback suggestions.

Processing: the user decides which suggestions to follow, edits the text using the terminal's input interface by inserting, deleting, or rewriting phrases, and confirms the changes.

Output: a revised version of the text created by the user, along with implicit information about what changes were made.

### Step 13:

The terminal records the editing operation content and transmits it to the server.

The terminal captures the differences between the original generated text and the revised text.

Input: original generated text, revised text, and user actions performed during editing.

Processing: the terminal computes a change set (for example, positions and types of edits) and packages the revised text and the change set into a data structure that can be processed by the server. The terminal then sends this data to the server over the communication network.

Output: a request containing editing operation content and the revised text received by the server.

### Step 14:

The server stores the editing operation content as self-evaluation history associated with the user's emotion data and generated text.

The server links how the user edited the text to the original emotion analysis and prompt configuration.

Input: editing operation content, revised text, original generated text, and associated emotion data.

Processing: the server inserts records into storage that bind the user identifier, original text, emotion label and intensity, generated text, revised text, and the set of edits into a unified data structure. The server indexes this data by time and user for later retrieval and analysis.

Output: a persistent self-evaluation history that can be used to refine future processing, including emotion analysis thresholds, prompt sentence templates, and feedback generation rules.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional computer-implemented text assistance systems that employ natural language processing and generative AI models mainly focus on producing a one-shot output based on a single user input. Such systems typically accept raw text, pass it as-is or with minimal formatting to a generative AI model, and then display the resulting text to the user. These systems do not effectively structure user inputs into rich, scenario-aware prompt sentences, and they do not maintain or exploit multi-turn interaction histories for adaptive improvement. As a result, these systems often generate responses that are generic, weakly aligned with the user's emotional intent, and poorly adapted to the user's evolving writing behavior.

From a computer technology standpoint, there is insufficient optimization of how prompt sentences are constructed, managed, and iteratively refined in cooperation with a generative AI model. Existing architectures generally lack mechanisms for dynamically modifying prompt templates or feedback policies based on accumulated per-user history. The processing logic at the server side is not configured to systematically associate prompt sentences, generated texts, and feedback information in a manner that can be reused to improve subsequent system behavior. Consequently, the computational resources of the generative AI model are not leveraged efficiently to guide long-term improvement of user writing, and the server fails to adapt its operation to different communication scenarios such as proposal messages, apology messages, and gratitude messages.

In addition, conventional systems do not provide a unified technical scheme in which a processor automatically (i) generates structured prompt sentences including scenario type, writing style type, and output language type; (ii) stores and correlates prompt-output-feedback triplets as record information; and (iii) uses this record information to adjust subsequent processing without manual reconfiguration. This leads to an underutilization of the server's data-processing capabilities and a lack of fine-grained control over the generative AI model's behavior across iterative interactions. There is therefore a need for an improved computer-implemented system that programmatically manages prompt sentences, feedback generation, and history-based adaptation in order to enhance the technical functioning of the text generation pipeline and provide more accurate, contextually appropriate emotional expression.

The specific processing by the specific processing unit 290 of the data processing device 12 in Example 2 is realized by the following means.

The present invention provides a server comprising a processor, a memory, and a communication interface configured to cooperate with at least one terminal device. The processor is configured to receive, via the communication interface, user input information including emotions and thoughts as text information together with additional information including at least a scenario type, a writing style type, and an output language type; to construct, based on the text information and the additional information, a structured prompt sentence according to a template, the prompt sentence being used as input to a generative AI model; to execute processing for supplying the prompt sentence to the generative AI model, obtaining a generated text as an output of the generative AI model, and generating feedback information related to at least emotional expression and word choice based on the generated text and the user input information; to store, in the memory, record information in which the prompt sentence, the generated text, and the feedback information are associated, and to analyze a plurality of items of the record information to extract a tendency for each user; and to dynamically adjust at least one of the prompt sentence template and an output policy of the feedback information based on the extracted tendency and on the scenario type, by switching among prompt sentence templates corresponding to different communication purposes and explicitly including the scenario type in the prompt sentence. This enables the server to technically improve the text generation pipeline by managing prompt sentences as structured data objects, by adaptively controlling the behavior of the generative AI model and the feedback generation module over iterative interactions, and by efficiently utilizing stored history information to provide scenario-appropriate, user-tailored emotional expressions, thereby enhancing the overall performance and functionality of the computer-implemented writing assistance system.

The term “processor” refers to a hardware-based information processing unit, such as a central processing unit or a graphics processing unit, that executes program instructions to perform arithmetic operations, logical operations, control operations, and data transfer operations.

The term “memory” refers to a hardware-based storage component, such as a volatile memory device or a non-volatile memory device, that stores program code, configuration data, user data, and intermediate processing results used by the processor.

The term “communication interface” refers to a hardware and software combination that enables data transmission between the server and an external device, including at least a network interface controller, a communication protocol stack, and associated drivers.

The term “server” refers to an information processing apparatus that includes at least the processor, the memory, and the communication interface, and that provides data processing, model execution, and storage services for one or more terminal devices over a communication network.

The term “terminal” refers to a user-operated information processing apparatus, such as a portable device or a stationary device, that communicates with the server via the communication interface, presents information to the user, and accepts input from the user.

The term “user input information” refers to data provided by the user via the terminal, including at least text information expressing emotions and thoughts, and optionally additional parameters specifying a scenario type, a writing style type, and an output language type.

The term “text information” refers to a sequence of characters or symbols representing natural language content that can be processed by a natural language processing algorithm or a generative AI model.

The term “additional information” refers to metadata associated with the text information, including at least a scenario type, a writing style type, and an output language type, that conditions the behavior of the generative AI model.

The term “scenario type” refers to a classification value indicating a communication purpose or context of the text to be generated, including at least categories such as a proposal message, an apology message, and a gratitude message.

The term “writing style type” refers to a classification value indicating stylistic characteristics of the desired text, such as formality level, tone, or narrative perspective, that constrain or guide the generative AI model.

The term “output language type” refers to a classification value indicating a target natural language in which the generative AI model is requested to generate the text, such as a specific human language identifier.

The term “prompt sentence” refers to a structured text string constructed according to a template, including at least the user input information and the additional information, and used as input to the generative AI model to control generation of the generated text.

The term “prompt sentence template” refers to a predefined structural pattern or format specifying how to combine the text information and the additional information into the prompt sentence, including fixed instruction parts and variable insertion parts.

The term “generative AI model” refers to a machine-learned model configured to perform natural language generation by receiving a prompt sentence as input and outputting a generated text, typically implemented as a neural network trained on language data.

The term “generated text” refers to natural language text produced by the generative AI model in response to the prompt sentence and representing an output candidate to be presented to the user.

The term “feedback information” refers to information generated by the processor based on at least the generated text and the user input information, the information including evaluations, comments, or suggestions regarding emotional expression, word choice, and other aspects of the generated text.

The term “request data” refers to a data structure transmitted from the terminal to the server, including at least the prompt sentence and optionally identifiers or control parameters used for processing at the server.

The term “response data” refers to a data structure transmitted from the server to the terminal, including at least the generated text and the feedback information, and optionally identification information or status information.

The term “record information” refers to stored association information in which at least one prompt sentence, one generated text, and corresponding feedback information are linked together in the memory for later retrieval and analysis.

The term “history information” refers to a set of multiple items of record information accumulated over a plurality of interactions with a user, including multiple prompt sentences, generated texts, and feedback information associated with that user.

The term “tendency” refers to a pattern or characteristic in a user's behavior or preferences, extracted from the history information, such as recurrent emotional expressions, preferred wording, or typical scenario usage.

The term “output policy of the feedback information” refers to rules or parameters that determine how the feedback information is generated and presented, including at least a level of detail, a degree of explicitness, and a selection of feedback categories.

The term “communication purpose” refers to an intended functional objective of the generated text, such as expressing affection, making an apology, or conveying gratitude, corresponding to the scenario type.

The term “analyze” refers to the act performed by the processor of processing the history information using computational operations to extract statistical or structural patterns, including categorization, frequency analysis, or clustering.

The term “dynamically adjust” refers to the act performed by the processor of modifying, during runtime and without manual reconfiguration by a human operator, at least one of the prompt sentence template and the output policy of the feedback information based on the extracted tendency or scenario type.

The term “visually present” refers to the operation of outputting the generated text and the feedback information in a human-readable form on a display device of the terminal, using at least text rendering.

The term “edit operation” refers to an input operation performed by the user on the generated text via the terminal, including at least insertion, deletion, or replacement of characters or phrases.

In an embodiment, a server cooperates with one or more terminals operated by users to provide a writing assistance system that utilizes a generative AI model. The server comprises at least one processor, a memory, and a communication interface connected to a communication network. The terminal comprises at least one processor, a memory, a communication interface, and a display device, and may be implemented as a smartphone, a tablet, a personal computer, or another information processing apparatus.

The server uses general-purpose computing hardware, such as a multi-core central processing unit and, optionally, a graphics processing unit. The server may execute an operating system such as a generic server operating system, and an application framework such as a web application framework or an application server runtime. The server may use a database management system, such as a relational database, to store prompt sentences, generated texts, feedback information, and history information.

The terminal uses general-purpose computing hardware such as a central processing unit and, optionally, a graphics processing unit integrated in a consumer device. The terminal may execute an operating system such as a mobile operating system or a desktop operating system, and may run a web browser or a native application framework.

The server uses a generative AI model that is implemented as a neural network, for example a transformer-based language model trained on large-scale text corpora. The generative AI model is stored in the memory and executed by the processor, optionally using GPU acceleration. The generative AI model receives a prompt sentence as a sequence of tokens, processes the tokens through multiple self-attention layers, feed-forward layers, and normalization layers, and outputs a sequence of tokens representing a generated text. The generative AI model may be fine-tuned on domain-specific data that emphasizes emotional expression and polite wording.

The user operates the terminal to input text information representing emotions and thoughts. The user may, for example, type free-form text expressing internal feelings and desired messages. The user may further select a scenario type, a writing style type, and an output language type via graphical controls displayed on the terminal. The terminal stores the user's input temporarily in its memory and may perform local validation of the input length and allowed character set.

The terminal sends the user input information and the additional information to the server through the communication interface. The server receives these data items and stores them temporarily in the memory. The server then constructs a prompt sentence using a prompt sentence template. The prompt sentence template is a structured text pattern stored in the memory, with placeholders for the scenario type, the writing style type, the output language type, and the user input information. The processor of the server fills the placeholders by inserting the user's emotions and thoughts, the scenario type, and other metadata.

The server, for example, generates a prompt sentence such as:
“Please generate a proposal message.
Emotions: happiness, love, hope.
Thoughts: I feel very happy and safe when I am with this person, and I want to tell them I want to spend my life with them.
Tone: sincere, warm, not too formal.
Output language: Japanese.”

The server uses deterministic string concatenation and formatting operations to build the prompt sentence in a reproducible way. The prompt sentence is then converted, by the server, into a token sequence using a tokenizer associated with the generative AI model. The tokenizer transforms the character sequence into a list of integer token identifiers, which are then supplied as input to the neural network.

The server executes the generative AI model with specific control parameters such as maximum output length, sampling temperature, and token sampling strategy (for example, top-k or nucleus sampling). The server sets these parameters programmatically based on the scenario type and user preferences stored in the database. For example, for a proposal message, the server may use a lower temperature and a narrower sampling distribution to obtain more stable and reliable wording; for a creative scenario, the server may use a higher temperature to allow more variation.

The generative AI model computes internal representations by performing linear transformations and non-linear activations on the token embeddings. The model calculates attention scores between tokens using scaled dot-product attention, applies multi-head attention to capture different contextual features, and propagates these features through stacked layers. The server controls the execution flow, monitors resource usage, and can terminate or limit computation if pre-defined resource constraints are reached.

The server obtains the output token sequence from the generative AI model and decodes it back into text information as the generated text. The server may apply post-processing rules, such as trimming trailing incomplete sentences, normalizing punctuation, and enforcing line-break insertion for improved display on the terminal. The server may also check that the generated text complies with length limits and language constraints by using language detection algorithms and simple character-level heuristics. If the generated text does not satisfy constraints, the server may automatically regenerate the text with adjusted model parameters, thereby improving robustness and reducing the need for repeated user requests. The server then generates feedback information using a feedback generation process. In one embodiment, the server uses the same generative AI model with a second prompt sentence that explicitly requests evaluation and suggestions. The server constructs a feedback prompt sentence that includes the generated text and the original emotional intention. For example, the server may construct a feedback prompt sentence such as:
“Evaluate the following message.
Analyze emotional expression and word choice.
Point out strengths and weaknesses, and suggest 2-3 concrete improvements.
Message: Being with you always fills my heart with peace and joy. I would be truly happy if we could continue walking through life side by side, sharing every moment together. Emotions intended: happiness, love, hope.”

The server again tokenizes this feedback prompt sentence, executes the generative AI model, and obtains feedback text. The server may apply heuristic rules to partition the feedback text into sections such as “strengths”, “weaknesses”, and “suggested revisions”. The server stores the prompt sentence, the generated text, and the feedback information together as record information in the database.

The server maintains a data structure for each user comprising multiple records, each record associating a prompt sentence, a generated text, feedback information, a timestamp, and identifiers for the scenario type and the writing style type. The server uses this history information to learn a tendency for each user. The server executes analysis algorithms on the history information, such as frequency analysis of vocabulary in user-edited texts, measurement of deviation between initial generative outputs and user final selections, and clustering of scenario usage patterns. By performing these computations at the server, the system identifies user-specific preferences, for example, preference for concise wording, avoidance of certain emotional intensities, or repeated use of particular scenarios.

The server modifies the prompt sentence template and the feedback output policy based on the extracted tendency. For example, if the server determines that the user repeatedly shortens generated messages, the server adjusts the prompt sentence template to explicitly request shorter outputs in future runs. If the server determines that the user tends to request more detailed emotional nuance, the server modifies the feedback generation logic to provide deeper semantic suggestions instead of only surface-level corrections. This adaptation is performed automatically by updating configuration parameters stored in the memory and by branching logic in the program, and does not require manual system reconfiguration. The terminal receives the generated text and the feedback information from the server and displays them to the user. The terminal may display the generated text in a main text area and the feedback information in a side panel or pop-up window. The user can read the generated text and the feedback, compare them with the original intention, and decide whether to edit the text. The terminal provides a text editor, implemented as a graphical user interface component, that allows the user to insert, delete, or modify portions of the generated text. The user may edit the generated text to add personal details or adjust tone. The terminal records the edited text and transmits it to the server along with information indicating that this text is a revised version of a previous generated text. The server constructs a new prompt sentence that includes the edited text and references previous feedback. For example, the server may construct a prompt sentence such as:
“Here is my revised proposal message based on your previous suggestions.
Please refine it further while preserving my personal tone.
Revised message: Being with you always fills my heart with peace and joy. From the day we first met at the small café, I have felt that my life is brighter with you. I want to continue walking through life by your side.
Tone: sincere, warm, not too formal.
Output language: Japanese.”

The server processes this new prompt sentence as described above, generating a refined text and updated feedback. The repeated use of prompt sentences that embed revision context enables the generative AI model to produce outputs that more closely follow user preferences while preserving the user's individual style.

The system improves computer technology in several ways. The server manages prompt sentences as structured data objects with scenario types, style types, and user tendencies encoded in a formalized way. This structure allows the server to control the generative AI model more precisely than conventional systems that pass only free-form prompts. As a result, the server reduces the number of iterations needed to reach a satisfactory output, thereby reducing network traffic and model invocation overhead. The server further improves data management by storing record information in an organized schema that enables efficient querying and analysis, leading to more precise adaptation over time.

The server also improves processing efficiency by adjusting model parameters and prompt templates based on historical patterns. When the server notices that short outputs are sufficient for a specific user and scenario, it can reduce the maximum token limit and narrow the sampling range. This reduces computational load on the neural network, shortens inference time, and reduces energy consumption. By dynamically selecting scenario-specific prompt templates, the server constrains the search space of the generative AI model, which can lead to more stable and accurate outputs with fewer tokens, providing a technical benefit in processing efficiency and accuracy.

The server uses a specific internal algorithm for feedback generation and adaptation that differs from human manual editing. The server evaluates generated texts not only based on semantic correctness but also using quantitative metrics derived from the neural network's token probabilities and attention distributions. For instance, the server may detect parts of the output with low confidence scores or unusually high perplexity and focus feedback suggestions on those sections. The server can also use sentiment analysis and intensity scores derived from internal feature vectors of the generative AI model to precisely adjust emotional strength. These operations are not simply mimicking human editing, but exploit internal numerical representations that humans do not directly access.

The generative AI model is trained using a supervised learning or reinforcement learning procedure. During training, the model receives tokenized prompt sentences and target texts, and the server or training environment computes a loss function such as cross-entropy between predicted token probabilities and ground-truth tokens. The model's weights are updated using gradient-based optimization, such as stochastic gradient descent or a variant thereof, in order to minimize the loss. The training data may be augmented with paraphrase pairs and emotional rephrasing examples to improve the model's capability in emotional expression. The training system may also employ techniques such as dropout, layer normalization, and gradient clipping to stabilize training. These details illustrate that the model is a concrete technical artifact and not an abstract black box.

The server architecture may be implemented in various alternative forms. In one embodiment, the generative AI model is hosted on the same physical server as the web application logic. In another embodiment, the model is hosted on a separate inference server, and the main server communicates with it via a specialized internal protocol. In a further embodiment, multiple generative AI models with different parameter sizes are available, and the server selects an appropriate model variant depending on resource constraints and user requirements, for example selecting a smaller model for short, low-latency messages and a larger model for complex, nuanced texts.

The terminal implementation may also vary. In one embodiment, the terminal runs a web application rendered by a browser, and all advanced processing occurs on the server. In another embodiment, the terminal performs part of the prompt sentence construction locally and transmits already formatted prompt sentences to the server. In yet another embodiment, the terminal maintains a local cache of recent generated texts and feedback to allow offline review by the user.

The system is not limited to any particular network configuration. The server may be located in a cloud computing environment or in an on-premises data center. The communication interface may use standard protocols such as TCP/IP and secure communication schemes such as TLS. The storage of record information may be implemented using relational tables, key-value stores, or document stores, as long as the association between prompt sentences, generated texts, and feedback information is preserved.

By combining structured prompt sentence management, history-based template adaptation, and scenario-specific control of the generative AI model, the system provides a concrete technical solution that improves the performance and functionality of computer-based text generation. The server not only automates parts of human writing but also modifies its own computational behavior over time, thereby enhancing speed, accuracy, and resource efficiency of the underlying computing system.

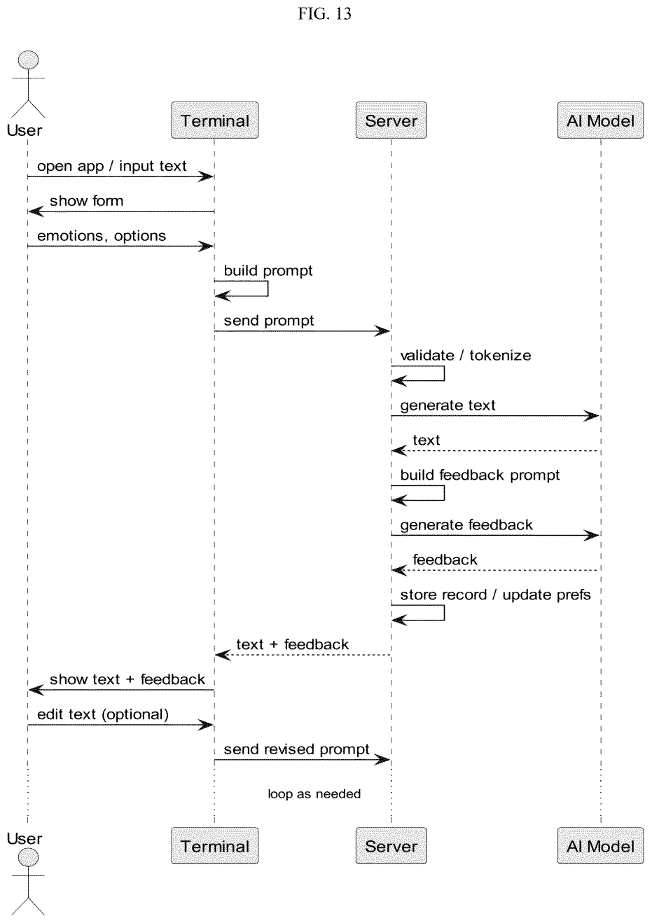

The following describes the processing flow using FIG. 13.

### Step 1:

The user operates the terminal to launch the application and open an input screen for emotional text entry. The input of this step is the user's internal emotions and thoughts, and the output is raw text information and selected options held in the terminal memory. The terminal displays text input fields and selection controls for scenario type, writing style type, and output language. The terminal captures keystrokes or touch events, converts them to character strings using the operating system's input subsystem, and stores the resulting text in a local data structure together with the current settings of the scenario type, writing style type, and output language.

### Step 2:

The terminal performs local validation and normalization of the user input. The input of this step is the raw text information and selected options from Step 1, and the output is validated and normalized text information. The terminal removes leading and trailing whitespace, replaces unsupported characters, and checks that required fields are not empty and that the text length lies within predefined limits. The terminal uses string manipulation functions to split lines, count characters, and ensure that the scenario type and output language type are set to valid values stored in a local configuration list.

### Step 3:

The terminal constructs a structured prompt sentence using a local prompt template. The input of this step is the validated text information and the additional information (scenario type, writing style type, output language type), and the output is a single prompt sentence string. The terminal selects a template according to the scenario type and inserts variable parts by concatenating fixed instruction phrases with the user's emotions and thoughts. For example, the terminal may generate:
“Please generate a proposal message.
Emotions: happiness, love, hope.
Thoughts: I feel very happy and safe when I am with this person, and I want to tell them I want to spend my life with them.
Tone: sincere, warm, not too formal.
Output language: Japanese.”

The terminal performs this data processing by executing string interpolation operations and storing the result in an internal buffer.

### Step 4:

The terminal packages the prompt sentence and metadata into a request object and transmits it to the server. The input of this step is the prompt sentence and associated metadata (user identifier, scenario type, style type, language type), and the output is a network message sent over the communication interface. The terminal creates a data structure containing the prompt sentence and metadata, serializes it into a byte sequence, and sends it via a secure communication protocol to the server. The terminal records a local timestamp and displays a loading indicator while waiting for the server response.

### Step 5:

The server receives the network message and parses the contained data. The input of this step is the raw network packet from the terminal, and the output is an internal representation of the prompt sentence and metadata in server memory. The server's communication interface converts the received byte stream into an application-level message, and the server processor uses a parsing routine to reconstruct the original data structure. The server stores the prompt sentence, user identifier, scenario type, style type, and language type in temporary variables for subsequent processing.

### Step 6:

The server validates and pre-processes the prompt sentence and metadata. The input of this step is the parsed prompt sentence and associated metadata, and the output is a verified prompt sentence and normalized control parameters. The server checks that the prompt sentence is not empty, that the scenario type is one of the supported categories, and that the length of the prompt sentence does not exceed a predefined threshold. The server may filter or mask prohibited substrings using pattern matching and adjust internal control parameters such as maximum output length and sampling temperature according to the scenario type and user profile stored in the database.

### Step 7:

The server converts the prompt sentence into a token sequence for the generative AI model. The input of this step is the verified prompt sentence string, and the output is a sequence of integer tokens. The server calls a tokenizer associated with the generative AI model, which performs subword segmentation by matching text fragments against a predefined vocabulary and computing integer indices. The server then stores the resulting token sequence in a format required by the neural network, such as a tensor array, and may prepend special control tokens representing scenario type or style constraints.

### Step 8:

The server executes the generative AI model to generate an output token sequence. The input of this step is the tokenized prompt sequence and model control parameters (maximum length, temperature, sampling strategy), and the output is a token sequence representing the generated text. The server loads the model weights into memory and performs a forward pass: the server applies embedding lookup to convert tokens to vectors, runs multi-layer self-attention and feed-forward computations, and iteratively predicts the next token distribution. The server selects each next token by applying the sampling strategy to the probability distribution, appends it to the sequence, and repeats until an end condition is met. The server monitors computation time and ensures that processing remains within resource limits.

### Step 9:

The server decodes the generated token sequence into natural language text and performs post-processing. The input of this step is the generated token sequence, and the output is a cleaned generated text string. The server applies the inverse of the tokenizer to map tokens back to characters, yielding raw generated text. The server then normalizes whitespace, corrects spacing around punctuation, and removes incomplete trailing fragments based on end-of-sentence markers. The server may check the language by applying a language detection algorithm and, if necessary, adjust or regenerate the output if it does not match the requested output language type.

### Step 10:

The server constructs a feedback prompt sentence for evaluation of the generated text. The input of this step is the generated text, the original user input information, and the scenario type, and the output is a feedback prompt sentence string. The server uses a feedback template that includes instructions to analyze emotional expression and word choice. The server inserts the generated text and the intended emotions into the template by performing string concatenation. For example, the server may construct:
“Evaluate the following message.
Analyze emotional expression and word choice.
Point out strengths and weaknesses, and suggest 2-3 concrete improvements.
Message: [generated text].
Emotions intended: [user emotions].”

The server stores this feedback prompt sentence in memory for the next processing step.

### Step 11:

The server tokenizes the feedback prompt sentence and runs the generative AI model to obtain feedback information. The input of this step is the feedback prompt sentence string, and the output is a feedback text string. The server tokenizes the feedback prompt sentence in the same manner as in Step 7, obtaining a token sequence. The server feeds this token sequence into the generative AI model, executes a forward pass with parameters tuned for evaluation output, and obtains a token sequence representing the feedback. The server decodes the token sequence into feedback text, then applies simple parsing rules, such as splitting by headings or line breaks, to identify sections like strengths, weaknesses, and suggestions.

### Step 12:

The server stores record information associating the prompt sentence, generated text, and feedback information. The input of this step is the prompt sentence, the generated text, the feedback text, and user identifiers, and the output is a persistent record in the database. The server creates a record structure containing fields for these elements, along with a timestamp and scenario type. The server executes database insert operations to write the record into a data table indexed by user identifier and interaction identifier. This data processing enables later retrieval and analysis of user-specific interaction history.

### Step 13:

The server analyzes accumulated history information to extract user tendencies and update control parameters. The input of this step is a set of multiple records for a user, and the output is updated prompt template settings and feedback output policies. The server runs analysis routines that compute statistics over the history, such as average message length, frequency of certain emotional descriptors, and typical revision patterns. Using these data, the server updates internal configuration values, for example lowering default output length for users who routinely shorten texts, or increasing feedback detail for users who frequently request further refinement. The server writes these updated parameters back to configuration storage so that they influence subsequent prompt construction and model execution.

### Step 14:

The server transmits the generated text and feedback information to the terminal. The input of this step is the final generated text and processed feedback text, and the output is a network response message containing both elements. The server constructs a response object with fields for generated text, feedback, scenario type, and relevant identifiers. The server serializes this object into a byte stream and sends it through the communication interface to the terminal. The server may also log the response status for monitoring and debugging purposes.

### Step 15:

The terminal receives the response message and renders the contents on the display. The input of this step is the network response from the server, and the output is a visual presentation of generated text and feedback on the terminal screen. The terminal parses the response, extracts the generated text and feedback sections, and populates user interface components such as a main text area and a feedback panel. The terminal may perform local formatting, such as highlighting suggested revisions or marking sentences referenced in the feedback. This graphical rendering is produced by drawing operations executed by the terminal's processor and graphics subsystem.

### Step 16:

The user reviews the generated text and feedback and optionally edits the text. The input of this step is the displayed generated text and feedback, and the output is an edited text string or an acceptance signal when no edits are performed. The user reads the text, decides which suggestions to adopt, and uses the terminal's input mechanisms to modify words or sentences. The terminal captures these edits, updates the internal text buffer, and, upon user request, marks the text as a revised message associated with a prior interaction.

### Step 17:

The terminal sends the revised message and context back to the server for further refinement. The input of this step is the edited text, together with identifiers referencing previous prompt and feedback information, and the output is a new request message containing a revision prompt. The terminal constructs a new prompt sentence, such as:
“Here is my revised proposal message based on your previous suggestions.
Please refine it further while preserving my personal tone.
Revised message: [edited text].
Tone: [desired tone].
Output language: [requested language].”

The terminal packages this prompt sentence and associated metadata into a request object and transmits it to the server through the communication interface, thereby initiating another cycle of Steps 5 through 15.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional text generation assistance systems that employ natural language processing and generative models typically treat user input as a single, static text sample and output a one-shot generated sentence. Such systems generally lack fine-grained mechanisms to (i) normalize and structure heterogeneous user inputs for reliable downstream processing, (ii) analyze and track user-specific emotional states over time, (iii) construct and adapt prompt sentences for a generative AI model based on evolving emotional context and user interaction history, and (iv) provide machine-interpretable, iterative feedback loops that improve both generated content and future system behavior. As a result, existing systems often produce output texts whose tone, structure, and style are poorly aligned with the user's emotional intent, and they are unable to systematically improve output quality or personalization across sessions.

From a computing technology standpoint, there is no integrated architecture that coordinates preprocessing modules, emotion analysis modules, prompt construction logic, generative AI models, quality evaluation engines, user-interaction tracking, and content distribution components as a single adaptive pipeline. In known approaches, each component operates in isolation or with limited context, causing inefficiencies such as repeated manual adjustments by the user, redundant generation calls, suboptimal prompt design, and inconsistent formatting for multiple distribution media. This leads to increased processing overhead on the server, degraded utilization efficiency of the generative AI model, and inconsistent latency and quality characteristics across different use cases.

Furthermore, existing systems lack a robust mechanism to encode user corrections and self-evaluations as structured history data that can be programmatically fed back into subsequent prompt generation and feedback generation processes. Without such a mechanism, the system cannot effectively learn from the user's editing behavior, cannot adapt the level of detail or strength of feedback, and cannot systematically optimize model prompts for different delivery channels. As a consequence, the overall computing process remains largely static and heuristic, rather than being dynamically optimized based on accumulated user-specific and emotion-specific data.

Accordingly, there is a need for an improved computer-implemented system that: (i) performs standardized text preprocessing to create consistent analysis data; (ii) performs emotion analysis and emotion change tracking based on user history; (iii) constructs and adaptively updates prompt sentences for a generative AI model using emotion results and interaction history; (iv) executes automated quality evaluation to generate structured feedback; (v) stores user corrections and self-evaluations as machine-readable history information; and (vi) optimizes reconstruction and distribution of generated text for multiple media types. By integrating these functions around a processor-centric architecture, the invention aims to improve the functioning of a server-based text generation platform itself, resulting in more efficient use of computing resources, more stable and controllable generation behavior, and more consistent output quality across varying contexts.

The specific processing by the specific processing unit 290 of the data processing device 12 in Application Example 2 is realized by the following means.

The present invention provides a server comprising a processor configured to receive, from a user terminal, natural language text expressing feelings or thoughts of a user and perform preprocessing on the natural language text, the preprocessing including at least normalization, removal of unnecessary symbols, and segmentation into lexical units to convert the natural language text into analysis data, execute emotion analysis processing on the analysis data to identify a type and an intensity of an emotion contained in the natural language text and, based on past emotion analysis results associated with the user, generate history information representing changes in the emotion of the user, construct, on the basis of the type and the intensity of the emotion, the history information representing the changes in the emotion, the natural language text, and a usage scene type, a prompt sentence for causing a generative AI model to generate a natural language response sentence, and input the prompt sentence into the generative AI model to cause the generative AI model to generate the response sentence, execute quality evaluation processing on the response sentence, the quality evaluation processing including at least grammatical checking processing and expression checking processing, and, based on a result of the quality evaluation processing, generate feedback information including concrete improvement points regarding grammar, vocabulary, writing style, and emotional expression of the response sentence, present the feedback information and the response sentence to the user via the user terminal, receive correction content and self-evaluation information from the user via the user terminal, and store the correction content and the self-evaluation information as history information associated with the user, adaptively change, for each user, a configuration of the prompt sentence and contents of the feedback information, on the basis of the stored history information and the history information representing the changes in the emotion of the user, and generate delivery data by converting a final version of the response sentence approved by the user into a format corresponding to a distribution medium and providing the delivery data as user-generated content via an external information distribution platform or an internal information distribution platform. This enables the server to implement an integrated and adaptive text generation pipeline in which preprocessing, emotion analysis, prompt construction, generative inference, automated quality evaluation, user-interaction logging, and media-specific reconstruction are cooperatively optimized, thereby improving computational efficiency, controllability, and personalization of generative AI-based text production beyond what is achievable with conventional systems.

The term “user” refers to a human individual or an organization that provides natural language text expressing feelings or thoughts to the system and interacts with the system via a user terminal.

The term “user terminal” refers to an information processing device, such as a mobile device, a personal computer, or a network-connected appliance, that provides a user interface for inputting natural language text, receiving response sentences and feedback information, and transmitting and receiving data to and from the server.

The term “server” refers to a computer system including at least one processor and a memory, configured to execute the processes of receiving user input, performing text preprocessing, emotion analysis, prompt construction, generative AI inference, quality evaluation, feedback generation, history management, and content distribution.

The term “processor” refers to a hardware execution unit, such as a central processing unit or a computing core, that executes machine-readable instructions stored in a memory to perform the functions described in the claims, including data reception, analysis, generation, evaluation, storage, and transmission.

The term “natural language text” refers to character data expressed in a human language, such as sentences or phrases, that represent feelings, thoughts, intentions, or narratives provided by the user.

The term “preprocessing” refers to a series of operations applied to the natural language text to convert the text into analysis data suitable for subsequent processing, the operations including at least normalization, removal of unnecessary symbols, and segmentation into lexical units.

The term “normalization” refers to a process of converting a natural language text into a canonical representation, including operations such as case conversion, character width unification, and standardization of punctuation, to reduce variation that is irrelevant to semantic analysis.

The term “removal of unnecessary symbols” refers to a process of detecting and deleting or replacing characters or tokens, such as extraneous punctuation, control characters, or markup artifacts, that do not contribute to the semantic or emotional analysis of the text.

The term “segmentation into lexical units” refers to a process of dividing a natural language text into smaller elements, such as tokens, words, or subword units, that can be processed by language analysis modules and generative models.

The term “analysis data” refers to an internal representation of the natural language text obtained by preprocessing, including token sequences, normalized strings, or encoded identifiers that are suitable for emotion analysis and generative processing.

The term “emotion analysis processing” refers to a computational procedure that receives the analysis data as input and outputs at least one emotion type and an emotion intensity value, using techniques such as natural language processing, statistical modeling, or machine learning.

The term “emotion type” refers to a categorical label representing a kind of emotion, such as joy, sadness, anger, fear, love, or gratitude, that is inferred from the user's natural language text by emotion analysis processing.

The term “emotion intensity” refers to a quantitative value, such as a score or probability, representing a strength or degree of a particular emotion type that is inferred from the user's natural language text.

The term “history information representing changes in the emotion” refers to data structures that store temporal sequences of emotion types and emotion intensities associated with a particular user, and that indicate how the user's emotional state has changed over time.

The term “usage scene type” refers to a category describing an intended application context of a response sentence, such as confession, gratitude, apology, blog post, or social media post, which is used as a condition for prompt construction and content formatting.

The term “generative AI model” refers to an artificial intelligence model, such as a neural network-based language model, that receives a prompt sentence as input and outputs a natural language response sentence by probabilistically generating tokens or words.

The term “prompt sentence” refers to natural language instruction data that is constructed by the processor based on analysis data, emotion information, usage scene type, and history information, and that is provided as input to the generative AI model to control the characteristics of the generated response sentence.

The term “response sentence” refers to a natural language text output by the generative AI model in response to a prompt sentence, and intended to express or refine the user's feelings, thoughts, or messages.

The term “quality evaluation processing” refers to a computational procedure that evaluates the response sentence along dimensions such as grammar, vocabulary, writing style, and emotional expression, and produces evaluation results or suggestions for improvement.

The term “grammatical checking processing” refers to a part of the quality evaluation processing that examines the response sentence for grammatical correctness, including syntax, agreement, and basic language rules, and identifies grammatical errors or suboptimal constructions.

The term “expression checking processing” refers to a part of the quality evaluation processing that examines the response sentence for stylistic and semantic appropriateness, including choice of words, register, fluency, and consistency with the intended emotional tone.

The term “feedback information” refers to structured data generated by the processor based on the quality evaluation processing, including specific improvement points, suggestions, or instructions regarding grammar, vocabulary, writing style, and emotional expression of the response sentence.

The term “correction content” refers to modifications made by the user to the response sentence or to related text, including additions, deletions, and replacements, and transmitted from the user terminal to the server as updated text data.

The term “self-evaluation information” refers to data provided by the user that indicates the user's subjective assessment of how well the response sentence expresses the user's intent or feelings, such as ratings, comments, or qualitative evaluations.

The term “history information associated with the user” refers to stored data that aggregates user-specific information, including past natural language texts, response sentences, emotion analysis results, correction contents, self-evaluation information, and interaction context.

The term “adaptively change” refers to a process in which the processor modifies parameters, templates, or structures used for prompt sentence construction and feedback information generation based on accumulated history information and detected emotional changes for each user.

The term “configuration of the prompt sentence” refers to structural and content aspects of the prompt sentence, including wording, constraints, instructions, examples, and parameterization, which influence the behavior of the generative AI model.

The term “contents of the feedback information” refers to the specific set of advice items, improvement points, and explanations that are included in the feedback information provided to the user.

The term “distribution medium” refers to a category of output channel for providing a final response sentence as content, including but not limited to web pages, blogs, social networking services, messaging platforms, and in-application feeds.

The term “delivery data” refers to formatted data generated from the final response sentence, including text, metadata, and structural markup, that conforms to requirements of a distribution medium and is suitable for transmission and display by an information distribution platform.

The term “final version of the response sentence approved by the user” refers to a version of the response sentence that has been reviewed, optionally edited, and explicitly accepted by the user as suitable for distribution.

The term “external information distribution platform” refers to a network-based service operated outside the server's domain, such as an online publication service or a social communication service, that receives delivery data and presents user-generated content to other users.

The term “internal information distribution platform” refers to a content distribution subsystem operated within the same system domain as the server, such as an in-application feed or internal portal, that receives delivery data and presents user-generated content to users of the system.

The term “distribution condition information” refers to information describing constraints and requirements associated with a distribution medium, including medium type, character-count limits, formatting rules, and attributes of an intended audience.

The term “medium-specific variations of the response sentence” refers to plural versions of a response sentence that are generated from a common underlying message but differ in length, formatting, or style so as to comply with respective distribution condition information for different media.

In one embodiment, a server cooperates with one or more user terminals to implement the claimed system. The server includes at least one processor, a main memory storing machine-readable instructions, a nonvolatile storage device storing models and configuration data, and a network interface configured to communicate with the user terminals via a communication network such as the Internet. The terminal includes a display, an input unit such as a keyboard or touch panel, a local memory, and a communication module.

The server executes an application program implemented, for example, in a high-level programming language running on an operating system. The server further executes software libraries for natural language processing and machine learning, such as a tokenization library, a sentiment analysis library, and a neural network inference engine. The server loads a generative AI model, such as a transformer-based language model, and an emotion analysis model, such as a classifier network, from the storage device into memory for inference.

The terminal provides a graphical user interface that allows a user to input natural language text expressing feelings or thoughts. The user inputs, for example, a sentence such as “I want to tell him that I love him” or “I want to express my gratitude to him” into a text field rendered by a browser or a native application. The terminal sends this natural language text, together with a usage scene type (for example, “confession” or “gratitude”) and a user identifier, to the server via a network protocol such as HTTPS.

The server stores the received natural language text and metadata in a data store. The server uses a predetermined data structure for each user input, such as a record including fields for an input identifier, user identifier, raw text, usage scene type, timestamp, and processing status. The server uses an indexed database to allow efficient retrieval of records by user identifier and time, which reduces disk access overhead when building emotion histories. The server performs preprocessing on the received natural language text. The server normalizes the text by converting characters to a canonical form, for example by lowercasing alphabetic characters, unifying punctuation, or converting full-width characters to half-width characters where applicable. The server removes unnecessary symbols, such as control characters, repeated punctuation, or markup tags, using pattern-matching logic. The server segments the normalized text into lexical units using a tokenizer, such as a wordpiece tokenizer or a byte-pair-encoding tokenizer, implemented by a natural language processing library. The server converts the tokens into token identifiers by referencing a vocabulary table loaded in memory. This conversion yields analysis data in the form of fixed-length or variable-length integer sequences suitable for input to the neural network models. The server performs emotion analysis processing on the analysis data. In one embodiment, the server uses a neural network classifier that has a transformer encoder architecture having multiple self-attention layers, layer normalization components, and feed-forward sublayers. The server inputs the token identifiers into an embedding layer, aggregates the output embeddings through the self-attention stack, and obtains a sequence representation. The server applies a pooling operation, such as using the embedding of a special classification token or an averaged embedding, to obtain a fixed-dimensional feature vector. The server passes this feature vector through one or more fully connected layers with non-linear activation functions to output an emotion type probability distribution and an emotion intensity score. The server stores the resulting emotion type and intensity, together with the input identifier, in an emotion results data structure.

The server maintains history information representing changes in the emotion of each user. The server obtains past emotion analysis results for the same user from the database, for example by fetching records ordered by timestamp. The server appends the new emotion type and intensity to a time-series data structure maintained per user. The server may compute summary statistics such as moving averages or trends in emotion intensity, which reduces the amount of data needed during prompt construction and improves computational efficiency by avoiding repeated re-analysis of older data.

The server constructs a prompt sentence for a generative AI model based on the analysis data, the emotion results, the usage scene type, and the emotion history. The server uses a template system in which a base template includes placeholders for emotion type, emotion intensity, original text, usage scene, and constraints such as length or tone. The server fills the placeholders with the actual values to form a complete natural language instruction. For example, when the usage scene is a confession and the emotion type is romantic love with high intensity, the server may generate a prompt sentence such as:
“The user wrote the following: ‘I want to tell him that I love him.’
Detected emotion: romantic love, positive, high intensity.
You are an experienced writer. Please generate a sincere and gentle confession message in English, consisting of 3 to 4 sentences, that clearly conveys deep affection without sounding too dramatic.”

In another example, when the usage scene is gratitude, the server may generate a prompt sentence such as:
“The user feels gratitude towards a close person and wrote: ‘I want to express my gratitude to him.’
Please generate a warm and polite thank-you message in 2 to 3 sentences that expresses appreciation in a natural and not exaggerated tone.”

The server provides the constructed prompt sentence and, optionally, context information such as previous user messages or emotion trends, as input to the generative AI model. In one embodiment, the generative AI model is a transformer-based autoregressive language model with multiple layers of masked self-attention. The server represents the prompt sentence as a sequence of token identifiers using the same or a related tokenizer. The server supplies the token identifiers to the model and performs inference by iteratively computing attention weights, hidden states, and output probabilities at each position. The server samples or selects tokens according to the output probability distribution, subject to parameter settings such as temperature and top-k or nucleus sampling thresholds, to generate a response sentence. The server stops generation when a termination token or a length constraint is reached, and decodes the generated tokens back to a natural language string.

The server stores the response sentence in a generated message record linked to the original input identifier and prompt identifier. The server executes quality evaluation processing on the response sentence. The server may call a grammar and style checking module that analyzes the text for syntactic correctness, agreement, and typical usage. This module can be implemented using rules, statistical models, or an additional neural sequence tagging network that labels spans requiring correction. The server optionally combines this with a language model likelihood score to detect unnatural wording or abrupt transitions. The server derives concrete improvement points, such as suggestions to replace specific phrases, to adjust sentence length balance, or to clarify vague expressions.

The server generates feedback information based on the quality evaluation processing. The server represents each improvement point as a structured element containing a target span index, a suggestion string, a category (such as grammar, vocabulary, style, or emotional tone), and a priority level. The server also generates human-readable explanation text, such as “Consider adding one specific shared memory to make your feelings more vivid” or “This phrase may sound too strong; you may use softer wording such as ‘I hope we can share more time together.’” The server packages the feedback information together with the response sentence and sends them to the terminal.

The terminal renders the response sentence in an editable text area and displays the feedback information as hints or annotations. The user reviews the response sentence and the feedback. The user may modify the response sentence by adding, deleting, or replacing text segments, for example to insert a personal anecdote or adjust the level of formality. The user may also provide self-evaluation information, such as selecting a score indicating how well the message matches the user's feelings, or entering comments such as “too formal” or “good, but needs more detail.” The terminal transmits the modified text and the self-evaluation information back to the server.

The server receives the correction content and self-evaluation information and stores them as history information associated with the user. The server may store the correction content as a pair of original and revised spans in order to derive editing patterns. The server performs additional emotion analysis on the revised text, using the same classifier network, and compares the new emotion type and intensity with those of the original natural language text and the initial response sentence. The server determines whether the user tends to increase or decrease emotion intensity, shift tone, or adjust formality. The server updates the user-specific emotion change history and a profile indicating editing preferences.

The server adaptively changes the configuration of the prompt sentence and the contents of the feedback information for subsequent interactions, based on the accumulated history information and emotion change history. For a user who frequently weakens strong phrases, the server may lower a “strength” parameter in the prompt templates so that the generative AI model produces more moderate expressions. For a user who repeatedly adjusts structure, the server may enrich the prompt sentence with explicit structure instructions, such as “Begin with a simple statement of your feeling, then describe one specific example, and finish with a short closing sentence.” This adaptive behavior reduces the number of iterations required for the user to obtain a satisfactory message, thereby reducing network calls to the generative AI model and lowering overall computation time and communication load.

The server further generates delivery data by converting a final version of the response sentence, approved by the user, into a format corresponding to a distribution medium. The server may attach metadata such as title, tags, and timestamps, and may apply markup for headings or paragraphs. When a distribution medium has strict character count or formatting constraints, the server may generate a specialized prompt sentence to cause the generative AI model to reconstruct the message for that medium. For example, for a social networking service with a character limit, the server may use a prompt sentence such as:
“Rewrite the following message as a short, friendly social media post under 200 characters, keeping the main emotional content:
[original final message].”

For a blog platform, the server may use a prompt sentence such as:
“Format the following text as a blog article with a short title and 2 to 3 section headings, keeping the tone warm and reflective:
[original final message].”

The server invokes the generative AI model with such prompt sentences to obtain medium-specific variations of the response sentence. The server packages the resulting text and metadata into a delivery data structure, such as a JSON or markup document, and sends it to an external or internal information distribution platform via an application programming interface. The server also stores a reference to the published content in a published content record for tracking.

This configuration improves computer technology itself by optimizing data flow and model usage across modules. The server reduces redundant computation by separating preprocessing and emotion analysis from generation, and by reusing history information for prompt adjustment. The adaptive prompt configuration improves generation quality and reduces the need for repeated re-generation, thereby saving processing time and network bandwidth. The explicit representation of user corrections and self-evaluations as machine-readable history information allows the server to automatically tune model inputs and feedback generation without human intervention. The combination of a transformer-based classifier for emotion analysis and a transformer-based generative model, integrated with rule-based and learned quality evaluation modules, creates a technical effect of more stable and predictable generation behavior under varying emotional conditions.

The server uses specific learning methods for the models. In one embodiment, the emotion analysis model is trained offline using a labeled corpus of text with emotion annotations. The server or an external training system optimizes the classifier by minimizing a loss function, such as cross-entropy between predicted emotion distributions and true labels, using gradient-based optimization. The system may use techniques such as minibatch training, learning rate scheduling, and regularization. The generative AI model is pretrained on a large corpus with a language modeling objective and optionally fine-tuned on domain-specific data. During inference in the deployed system, the server uses fixed model parameters but can apply decoding strategies such as beam search, top-k sampling, or nucleus sampling to control diversity and coherence.

The server uses specific data structures for efficient management of history information. Emotion histories are stored as time-series arrays or as key-value pairs where each key corresponds to a timestamp or session identifier and each value contains emotion type and intensity. Correction patterns can be stored as aligned token sequences representing original and revised spans. Self-evaluation information can be stored as numerical fields and text comments. By structuring these data, the server can compute user-specific adaptation parameters in constant or logarithmic time with respect to the number of past sessions, improving scalability when many users are served.

The server performs certain non-conventional operations that differ from mere human editing or manual content curation. For example, the server automatically synthesizes multi-source context (raw text, emotion type, emotion intensity, usage scene type, and emotion history) into a single prompt sentence following a deterministic algorithm and learned parameterization. The server automatically adjusts the strength and structure of prompts based on quantitative patterns derived from the user's correction behavior rather than simply mirroring explicit user instructions. The server also automatically segments and annotates feedback content and associates it with specific spans of the response sentence, enabling the terminal to provide interactive visual feedback not achievable with a static text suggestion.

Alternative embodiments can be implemented. In one embodiment, the emotion analysis model uses a recurrent neural network or a convolutional network instead of a transformer. In another embodiment, the quality evaluation module uses a sequence-to-sequence model that predicts corrected text and the server derives feedback from the differences. In still another embodiment, the server executes some modules, such as preprocessing or light emotion analysis, on the terminal to reduce uplink bandwidth by sending token identifiers rather than raw text. In a further embodiment, the server distributes the generative AI model across multiple computing nodes and uses a model-parallel or pipeline-parallel architecture to reduce latency for long prompts and responses.

The server, terminal, and user thus cooperate in a technically specific architecture. The server implements a pipeline that transforms raw user input into analysis data, emotion results, adaptive prompt sentences, generated response sentences, structured feedback, history information, and medium-specific delivery data. The terminal implements user interaction and visualization based on structured feedback. The user provides emotional input, performs corrections, and approves final content. The integrated system provides not only automated generation of text but also a technical improvement in how a computing platform orchestrates natural language processing modules, neural network inference, and adaptive control of generative AI behavior, resulting in improved processing efficiency, accuracy of emotional alignment, reduction of unnecessary regeneration cycles, and improved consistency of content across multiple distribution media.

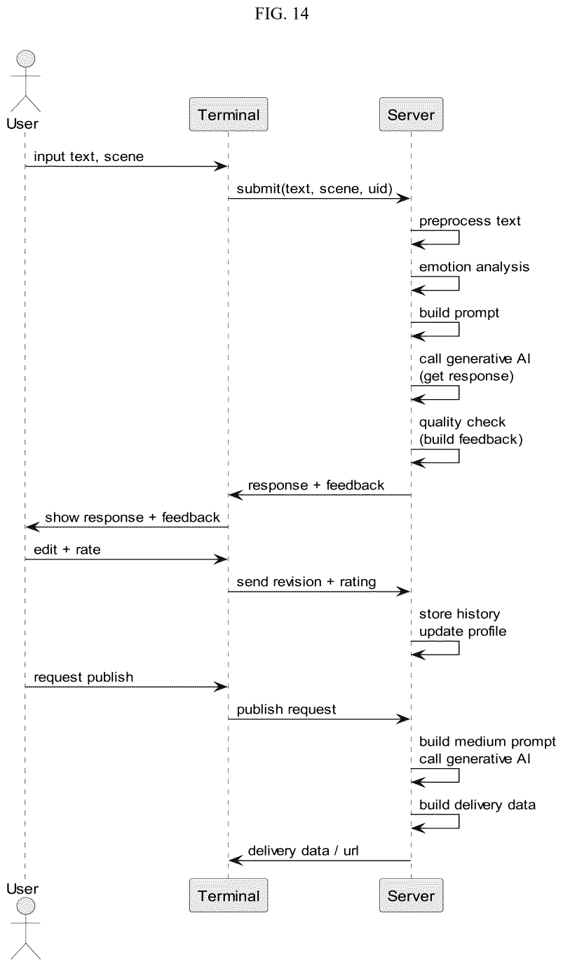

The following describes the processing flow using FIG. 14.

### Step 1:

User inputs emotion-related text and scenario on the terminal.

User enters natural language text expressing feelings or thoughts, such as “I want to tell him that I love him” or “I want to express my gratitude to him,” into a text input field displayed on the terminal. User selects a usage scene type, such as “confession,” “gratitude,” “apology,” or “blog post,” from a menu or button list.

Input: raw natural language text, selected usage scene type, and implicit user identifier stored on the terminal.

Output: a structured request object in the terminal's memory.

Terminal creates a structured object including fields such as user ID, raw text, usage scene type, and timestamp. Terminal performs basic client-side validation, such as checking that the text is not empty and trimming leading and trailing spaces. Terminal prepares the object for transmission over the network.

### Step 2:

Terminal transmits the structured request to the server.

Terminal encodes the structured request as a message formatted for a communication protocol (for example, an HTTPS POST request body). Terminal attaches authentication information such as a token or session cookie.

Input: structured request object (user ID, raw text, usage scene type, timestamp) and authentication token.

Output: network message sent to the server.

Terminal sends the message to a predefined server endpoint, such as “/api/text/submit,” over a secure network connection. Terminal records a local request identifier so that it can correlate future responses.

### Step 3:

Server receives and validates the request.

Server accepts the network message using a web framework or network library, and parses the request body into an internal representation. Server verifies the authentication token and checks that required fields are present and syntactically valid.

Input: network message from the terminal (structured request plus authentication data).

Output: validated request object in server memory, or an error response if validation fails. Server constructs a validated request object including user ID, raw text, usage scene type, and timestamp. If validation fails, Server generates an error response and stops processing; otherwise, Server proceeds to store the input.

### Step 4:

Server stores the raw input and initializes processing records.

Server inserts a new record into a database table dedicated to user inputs. The record contains a generated input ID, user ID, raw text, usage scene type, timestamp, and initial processing status.

Input: validated request object (user ID, raw text, usage scene type, timestamp).

Output: input record stored in the database, and generated input ID returned in server memory.

Server uses a database engine to generate a unique input ID and indexes the record by user ID and timestamp. Server updates the processing status field to indicate that preprocessing is pending.

### Step 5:

Server performs text preprocessing to create analysis data.

Server loads the raw text from the input record and passes it to a preprocessing module. The module normalizes characters (for example, lowercasing, unifying punctuation), removes unnecessary symbols (for example, control characters, repeated punctuation, markup artifacts), and segments the text into lexical units using a tokenizer. Server maps tokens to token identifiers using a vocabulary table.

Input: raw natural language text string from the input record.

Output: analysis data consisting of normalized text, token list, and token identifier sequence. Server stores the normalized text and token identifiers in associated fields linked to the input ID. Server sets a flag indicating that analysis data is ready for emotion analysis and generation.

### Step 6:

Server performs emotion analysis and updates user emotion history.

Server passes the analysis data, in the form of token identifiers, to an emotion analysis model. The model, implemented as a neural network classifier, computes hidden representations and outputs a probability distribution over emotion types and a continuous score for intensity. Server selects the emotion type with maximum probability and reads the corresponding intensity.

Input: analysis data (token identifier sequence associated with the input ID).

Output: emotion type label and emotion intensity score.

Server writes an emotion result record containing input ID, emotion type, and intensity.

Server retrieves past emotion results for the same user, appends the new result to a time-ordered list, and computes summary values such as trends in intensity. Server stores updated emotion history in a separate data structure keyed by user ID.

### Step 7:

Server constructs a prompt sentence for the generative AI model.

Server selects a prompt template based on the usage scene type and system configuration.

Server fills template placeholders with the original text, the detected emotion type, the intensity, and any relevant emotion history features.

Input: original natural language text, usage scene type, emotion type, emotion intensity, and user emotion history.

Output: a natural language prompt sentence to be used as input to the generative AI model.

Server generates, for example, a prompt sentence such as:
“The user wrote the following: ‘I want to tell him that I love him.’
Detected emotion: romantic love, positive, high intensity.
You are an experienced writer. Please generate a sincere and gentle confession message in English, consisting of 3 to 4 sentences, that clearly conveys deep affection without sounding too dramatic.”

Server stores the constructed prompt sentence in a prompt log table linked to the input ID.

### Step 8:

Server invokes the generative AI model to generate a response sentence.

Server tokenizes the prompt sentence into token identifiers and sends them to the generative AI model for inference. The model computes attention scores and hidden states layer by layer, and generates new tokens autoregressively according to the output probabilities, subject to decoding parameters such as maximum length and sampling thresholds.

Input: prompt sentence as a string and its token identifier sequence.

Output: generated response sentence in the form of a token identifier sequence and decoded natural language text.

Server decodes the generated tokens into text, obtaining a response such as “When I am with you, every day feels special. Your presence gives me strength and happiness. I love you deeply and hope we can share our future together.” Server stores the response text and associated metadata in a generated message record linked to the input ID and prompt ID.

### Step 9:

Server performs quality evaluation on the response sentence.

Server submits the response text to a quality evaluation module that checks grammar, vocabulary, writing style, and emotional expression. The module may apply rule-based grammar checks, a statistical or neural scorer for fluency, and a classifier for tone.

Input: response sentence text obtained from the generative AI model.

Output: quality evaluation results including detected issues and corresponding scores.

Server aggregates the evaluation outputs into a structured assessment, identifying specific segments of the response that may require improvement, such as awkward phrases or mismatched tone. Server records the assessment in a quality evaluation table associated with the response.

### Step 10:

Server generates feedback information for user improvement.

Server converts quality evaluation results into feedback information. Server maps each detected issue to a user-facing suggestion, including a description of the problem, an example correction, and a category.

Input: structured quality evaluation results for the response sentence.

Output: feedback information items describing concrete improvement points.

Server generates feedback sentences such as “Consider adding one concrete memory you share with him to make your feelings more vivid” or “This phrase may sound too strong; you may use softer wording such as ‘I hope we can spend more time together.’ ” Server stores the feedback items in a feedback record linked to the response.

### Step 11:

Server sends the response and feedback to the terminal.

Server composes a response payload including the generated response sentence, feedback information items, emotion type, emotion intensity, and identifiers such as input ID and response ID. Server serializes this payload into a format suitable for network transmission.

Input: response sentence text, feedback information, and associated identifiers.

Output: network response message sent to the terminal.

Server transmits the response message via HTTPS back to the terminal that issued the original request.

### Step 12:

Terminal displays the response sentence and feedback to the user.

Terminal receives the network response message and decodes the payload into local structures. Terminal places the response sentence into an editable text area and displays feedback information as a list or as annotations near relevant parts of the text.

Input: network response message from the server (response sentence, feedback information, identifiers).

Output: rendered interface on the terminal display and an editable text buffer containing the response sentence.

Terminal initializes interaction state for this session, allowing the user to perform edits and evaluations.

### Step 13:

User edits the response sentence and provides self-evaluation.

User reads the generated response and the associated feedback. User modifies the text directly in the editable area, such as by adding a concrete example, replacing formal phrases with more casual wording, or shortening long sentences. User provides self-evaluation, for example by selecting a rating or entering a comment about how well the message reflects the intended feelings.

Input: displayed response sentence and feedback items on the terminal.

Output: revised text and self-evaluation values in the terminal memory.

User confirms the edits and evaluation by pressing a button such as “Save” or “Next,” instructing the terminal to send the updated information to the server.

### Step 14:

Terminal transmits correction content and self-evaluation to the server.

Terminal packages the revised text, the self-evaluation information, and the identifiers received from the server into a structured payload. Terminal verifies that the revised text is not empty and that the self-evaluation format is valid.

Input: revised response sentence text, self-evaluation information, and identifiers (input ID, response ID).

Output: network message containing correction content and self-evaluation, sent to the server.

Terminal sends the message to a dedicated endpoint, such as “/api/text/review,” over the network.

### Step 15:

Server stores correction content and self-evaluation as history information.

Server receives the review message and parses the revised text and self-evaluation. Server stores the revised version in a revisions table as a new record linked to the original input ID and response ID. Server stores the self-evaluation scores and comments in a user evaluation table.

Input: correction content (revised text) and self-evaluation data from the terminal.

Output: updated history information in the database, including revision and evaluation records.

Server may compute the differences between the original response sentence and the revised text at token or character level, recording the positions and types of edits for later analysis.

### Step 16:

Server re-analyzes the revised text for emotion and updates adaptation parameters.

Server executes emotion analysis on the revised text using the same or a simplified classifier as used previously. Server compares the new emotion type and intensity with those of the original natural language text and the initial response sentence.

Input: revised response sentence text from the revision record, and prior emotion analysis results for the same input.

Output: updated emotion analysis results and adjusted adaptation parameters for the user.

Server updates the user's emotion history and identifies trends such as consistent softening or intensifying of expressions by the user. Server computes adaptation parameters, such as tone strength or structural guidance level, and stores them in a user profile record.

### Step 17:

Server adaptively adjusts future prompt sentence configuration and feedback content.

Server uses the adaptation parameters stored in the user profile to modify templates and rules used in subsequent sessions. For example, Server sets a lower target intensity in prompt sentences for users who repeatedly reduce emotional intensity, or adds more explicit structure guidance for users who frequently adjust paragraph structure.

Input: user profile containing adaptation parameters and history information.

Output: updated prompt templates and feedback generation rules stored in configuration data.

Server writes modified template parameters and rule weights into a configuration store, ensuring that future prompt sentence construction and feedback generation operations will use user-specific adjustments, thereby reducing future editing iterations.

### Step 18:

Server prepares delivery data when the user approves final content for distribution.

When a distribution request is received, Server retrieves the final approved response sentence and the target distribution medium, such as “blog” or “social media.” Server may construct an additional prompt sentence to instruct the generative AI model to tailor the content for the medium, for example:
“Rewrite the following message as a short, friendly social media post under 200 characters, keeping the main emotional content: [final message].”

Input: final approved response sentence text, user-selected distribution medium, and optional distribution condition information.

Output: medium-specific message text and associated delivery data structure.

Server uses the generative AI model to generate a medium-specific variation when needed and then converts the text and metadata into a delivery format, such as a structured document or a payload for an external application programming interface.

### Step 19:

Server transmits delivery data to an information distribution platform or back to the terminal.

Server sends the delivery data to an external or internal information distribution platform using a corresponding application programming interface, or returns it to the terminal for manual posting.

Input: delivery data containing medium-specific message text and metadata.

Output: published content on the distribution platform, or formatted text ready for publication on the terminal.

Server records publication status, including platform identifiers and URLs, in a published content record linked to the user and the input ID, completing the processing flow for that content instance.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

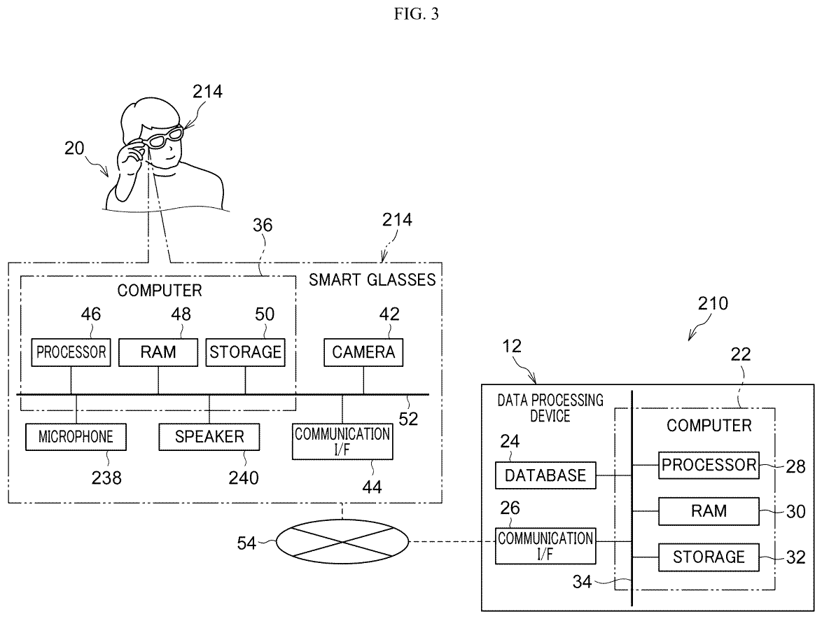

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

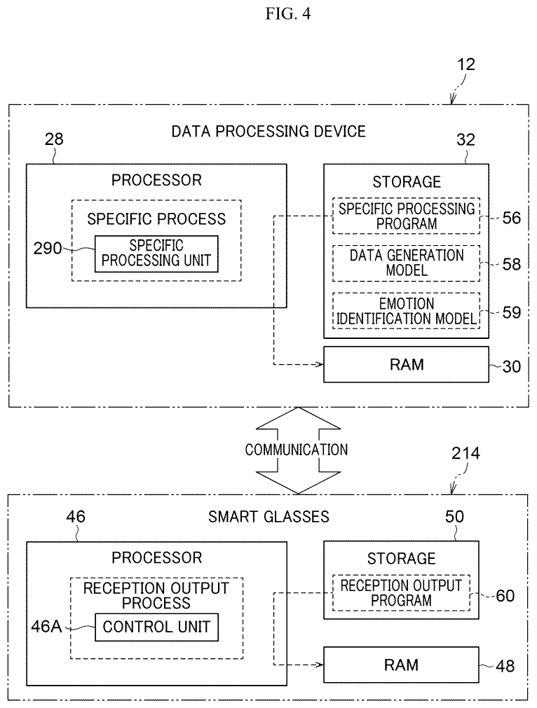

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

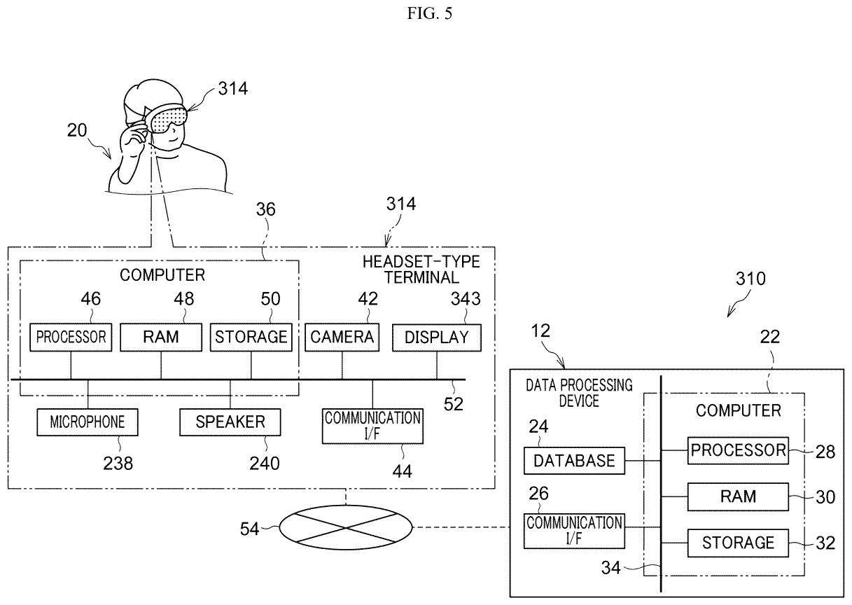

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

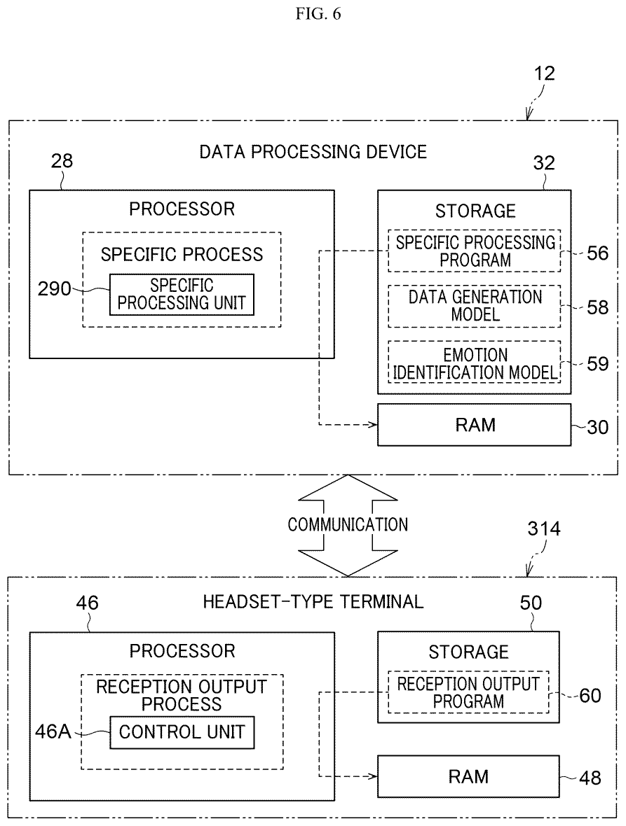

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

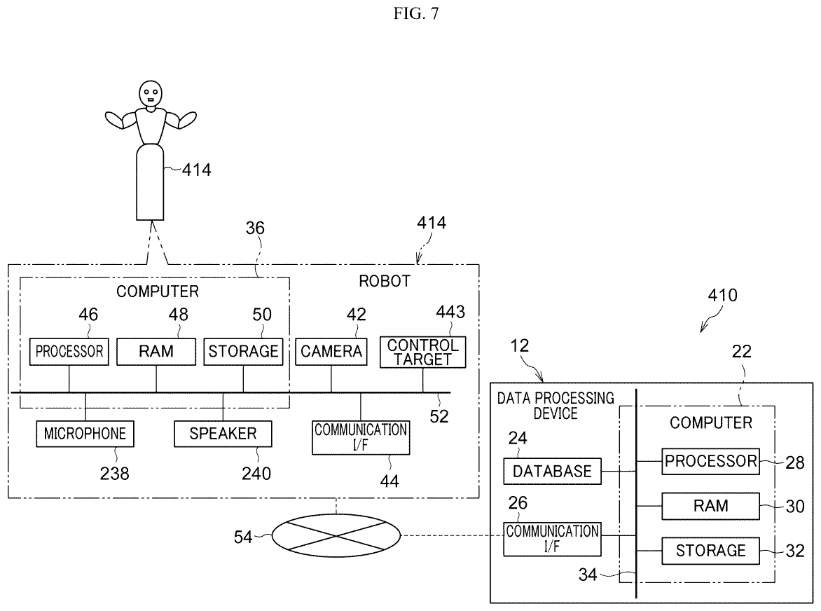

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

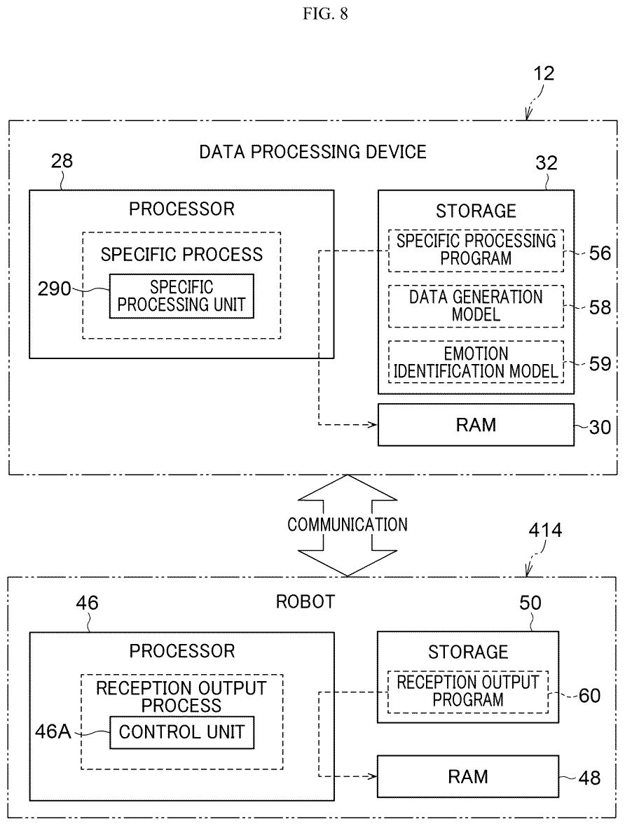

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

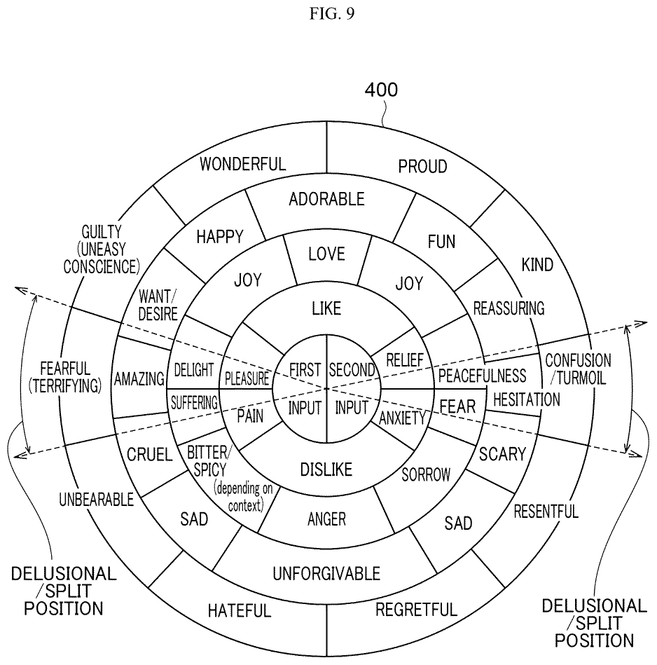

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

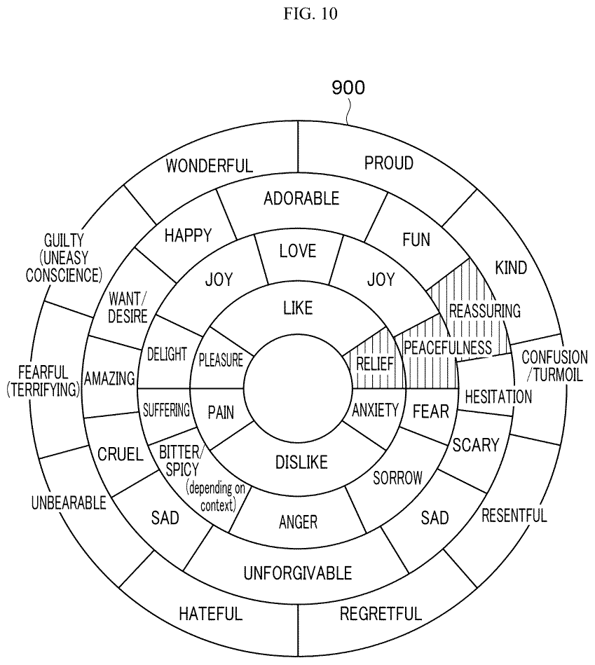

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (Saas).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
acquire, via a terminal, text data including a user's feelings or thoughts as a prompt sentence from the user, and generate structured data representing the prompt sentence, and
generate model input data for input to a generative AI model based on the structured data representing the prompt sentence, and transmit the model input data to the generative AI model so as to cause the generative AI model to generate text data expressed in natural language, and acquire the generated text data, and
cause the generative AI model or an evaluation information processing apparatus to generate feedback data including evaluation information and improvement points for content of expression in the text data, based on the prompt sentence and the text data, and acquire the feedback data, and
transmit the text data and the feedback data to the terminal and cause the terminal to present the text data and the feedback data to the user, and
acquire, from the user, revised text data as a new prompt sentence, the revised text data being revised based on the feedback data, and perform control to repeatedly execute processing for generation of the text data by the generative AI model and processing for generation of the feedback data.

### (Supplementary 2)

The system according to supplementary 1,
wherein the processor is configured to
generate input guide information regarding length, specificity, and degree of emotional expression of the prompt sentence to be input by the user, in accordance with content of the feedback data presented on the terminal, and transmit the input guide information to the terminal so as to cause the terminal to display the input guide information and thereby guide a subsequent input of the prompt sentence by the user.

### (Supplementary 3)

The system according to supplementary 1,
wherein the processor is configured to
store, in a storage medium, sets each including the prompt sentence, the text data, and the feedback data in association with identification information, and execute statistical processing or machine learning processing on a plurality of the stored sets so as to update a generation condition for the model input data to be supplied to the generative AI model or a generation condition for the feedback data.

### Application Example 1

### (Supplementary 1)

A system comprising a processor,
wherein the processor is configured to
receive character information relating to a user's emotion or thought, convert the character information into structured data by performing preprocessing including morphological analysis, segmentation, normalization, and vocabulary transformation, and input the structured data into a machine learning model to specify, as numerical data, a type of emotion and an intensity of the emotion,
generate, on the basis of the numerical data and the character information, a prompt sentence including at least the type of emotion, the intensity of the emotion, an outline of an event, and an expression policy, and transmit, via a communication network, request data including the prompt sentence as input data to an external generative information processing model so as to instruct the external generative information processing model to generate natural language text reflecting the user's emotion,
analyze natural language text received from the external generative information processing model by evaluating, as evaluation criteria, at least a sentence structure, a concreteness of emotional expressions, a presence or absence of event description, and a presence or absence of sensory description, generate, on the basis of a result of the evaluation, feedback information including improvement proposals indicating additional description portions and modification policies for the user to revise the natural language text, and output the feedback information to a terminal apparatus, and
receive editing operation content performed by the user on the natural language text and the feedback information, and store the editing operation content in association with the character information and the numerical data as a self-evaluation history of the user.

### (Supplementary 2)

The system according to supplementary 1,
wherein the processor is configured to
for a plurality of pieces of character information input from the user in a time series, calculate, for each piece of character information, the type of emotion and the intensity of the emotion as numerical data, calculate a temporal change amount of the numerical data to extract an emotion change pattern, and control dynamic modification of at least one of content of the prompt sentence and content of the feedback information in accordance with the emotion change pattern.

### (Supplementary 3)

The system according to supplementary 1,
wherein the processor is configured to
acquire usage information indicating that the natural language text is to be provided as user-generated content in an external content distribution service, and, on the basis of the usage information, the type of emotion, and the intensity of the emotion, include in the prompt sentence conditions indicating at least one of a length of content, a writing style, an output format, and a target audience, thereby optimizing the input data to the external generative information processing model.

### Example 2

### (Supplementary 1)

A system comprising a processor, a memory, and a communication interface,
wherein the processor is configured to
receive, via a terminal, user input information including emotions and thoughts as text information, and accept the text information together with additional information including at least a scenario type, a writing style type, and an output language type,
construct, based on the text information and the additional information, a prompt sentence to be used as input to a generative AI model, the prompt sentence being generated according to a template and formed as a data structure,
transmit, via the communication interface, request data including the prompt sentence to a server, and receive, from the server via the communication interface, response data including a generated text and feedback information,
execute, in the server, processing for extracting the prompt sentence from the request data, causing execution of the generative AI model based on the prompt sentence to generate the generated text, and further generating the feedback information related to emotional expression and word choice based on at least the generated text and the user input information,
store, in the memory, association information in which the prompt sentence, the generated text, and the feedback information are associated as record information, and perform processing to adjust at least one of subsequent generation of the prompt sentence and content of the feedback information using the record information,
and present, via the terminal, the generated text and the feedback information visually to the user, accept an edit operation by the user on the generated text, and generate, based on an edited text and additional input information including past feedback information, a new prompt sentence to be retransmitted to the server, thereby repeatedly causing execution of processing for generation of the generated text and the feedback information and supporting improvement of the user's writing ability.

### (Supplementary 2)

The system according to supplementary 1,
wherein the processor is configured to
analyze history information including a plurality of prompt sentences, generated texts, and feedback information, extract a tendency for each user based on the history information, and dynamically change at least one of the template of the prompt sentence and an output policy of the feedback information in accordance with the extracted tendency.

### (Supplementary 3)

The system according to supplementary 1,
wherein the processor is configured to
switch, in accordance with the scenario type, among prompt sentence templates corresponding to communication purposes including at least a proposal message, an apology message, and a gratitude message, and explicitly include the scenario type in the prompt sentence so as to cause the generative AI model to generate the generated text with emotional expression and writing style adapted to the scenario.

### Application Example 2

### (Supplementary 1)

A system comprising a processor,
wherein the processor is configured to
receive, from a user terminal, natural language text expressing feelings or thoughts of a user, and perform preprocessing on the natural language text, the preprocessing including at least normalization, removal of unnecessary symbols, and segmentation into lexical units, to convert the natural language text into analysis data,
execute emotion analysis processing on the analysis data to identify a type and an intensity of an emotion contained in the natural language text, and, based on past emotion analysis results associated with the user, generate history information representing changes in the emotion of the user,
construct, on the basis of the type and the intensity of the emotion, the history information representing the changes in the emotion, the natural language text, and a usage scene type, a prompt sentence for causing a generative AI model to generate a natural language response sentence, and input the prompt sentence into the generative AI model to cause the generative AI model to generate the response sentence,
execute quality evaluation processing on the response sentence, the quality evaluation processing including at least grammatical checking processing and expression checking processing, and, based on a result of the quality evaluation processing, generate feedback information including concrete improvement points regarding grammar, vocabulary, writing style, and emotional expression of the response sentence,
present the feedback information and the response sentence to the user via the user terminal, receive correction content and self-evaluation information from the user via the user terminal, and store the correction content and the self-evaluation information as history information associated with the user,
adaptively change, for each user, a configuration of the prompt sentence and contents of the feedback information, on the basis of the stored history information and the history information representing the changes in the emotion of the user, and
generate delivery data by converting a final version of the response sentence approved by the user into a format corresponding to a distribution medium, and provide the delivery data as user-generated content via an external information distribution platform or an internal information distribution platform.

### (Supplementary 2)

The system according to supplementary 1,
wherein the processor is configured to execute additional emotion analysis processing on the correction content and the self-evaluation information received from the user, compare a type and an intensity of an emotion contained in the correction content with a type and an intensity of an emotion contained in the natural language text and in the response sentence, track in real time a change in the emotion of the user based on the comparison, and update, in accordance with the change in the emotion, at least one of a level of detail of advice included in the feedback information, a strength of expressions recommended in the feedback information, and contents of instructions regarding a structure of the response sentence.

### (Supplementary 3)

The system according to supplementary 1,
wherein the processor is configured to optimize the prompt sentence for causing the generative AI model to reconstruct the response sentence into a form compliant with distribution condition information, the distribution condition information including at least a type of the distribution medium, a character-count constraint, a formatting requirement, and a target audience attribute, and, based on a result of the emotion analysis processing and the history information associated with the user, cause the generative AI model, by using the optimized prompt sentence, to generate medium-specific variations of the response sentence, and provide the medium-specific variations as the delivery data.

What is claimed is:

1. A system comprising:
circuitry configured to:
receive, via a communication interface coupled to a packet-switched network, natural-language input text from a terminal device, the natural-language input text representing a user's feelings or thoughts, and perform preprocessing on the natural-language input text, the preprocessing comprising at least tokenization, segmentation, and normalization, to generate analysis data;
execute emotion analysis processing on the analysis data using a trained emotion analysis model to compute an emotion type and an emotion intensity value represented in the natural-language input text, and generate structured data encoding the emotion type, the emotion intensity value, and contextual parameters extracted from the natural-language input text;
construct model input data for a generative model based on the structured data, transmit the model input data to the generative model via the communication interface, and receive generated text data from the generative model, the generated text data expressing the feelings or thoughts indicated in the natural-language input text in a natural-language form;
generate feedback data comprising evaluation information and improvement point information for the generated text data based on the natural-language input text and the generated text data, and transmit the generated text data and the feedback data to the terminal device via the communication interface;
receive revised input text from the terminal device as a new prompt sentence based on the feedback data, and repeat the processing for generating the model input data, receiving the generated text data, and generating the feedback data; and
store, in a storage device, interaction sets each comprising the natural-language input text, the model input data, the generated text data, and the feedback data in association with user identification information, and execute statistical processing or machine learning processing on a plurality of stored interaction sets to update at least one of a generation condition for the model input data and a generation condition for the feedback data.

2. The system according to claim 1, wherein constructing the model input data comprises selecting a template based on at least one of a scenario type, a writing style type, and an output language type, and embedding the structured data into the selected template to form the model input data.

3. The system according to claim 2, wherein the scenario type is identified from the natural-language input text by the circuitry based on keyword matching against a scenario category table, and wherein the writing style type is determined based on the emotion type computed by the emotion analysis model.

4. The system according to claim 1, wherein the circuitry is configured to generate input guide information based on content of the feedback data, the input guide information specifying at least one of a recommended length, a recommended specificity level, and a recommended degree of emotional expression for a subsequent input from the user, and transmit the input guide information to the terminal device to guide the subsequent input.

5. The system according to claim 4, wherein the input guide information is generated by constructing a guide prompt sentence that includes the feedback data and a format specification for the guide information, transmitting the guide prompt sentence to the generative model, and extracting the input guide information from a response returned by the generative model.

6. The system according to claim 1, wherein executing the statistical processing on the stored interaction sets comprises computing, for each emotion type, a distribution of emotion intensity values across the stored interaction sets, and adjusting an intensity scaling factor applied to the structured data during construction of the model input data based on the computed distribution.

7. The system according to claim 6, wherein the machine learning processing comprises fine-tuning the trained emotion analysis model using labeled samples extracted from the stored interaction sets, wherein the labeled samples are identified based on interaction sets in which the revised input text indicates user satisfaction with the generated text data.

8. The system according to claim 1, wherein the feedback data is generated by transmitting an evaluation prompt sentence comprising the natural-language input text and the generated text data to the generative model or to a separate evaluation apparatus, and receiving the feedback data as a response from the generative model or the evaluation apparatus.

9. The system according to claim 8, wherein the evaluation prompt sentence includes a scoring rubric specifying evaluation criteria comprising at least an emotional fidelity criterion and a linguistic naturalness criterion, and wherein the feedback data comprises a numerical score for each criterion together with a textual description of improvement points.

10. The system according to claim 1, wherein the preprocessing further comprises vocabulary transformation that replaces colloquial expressions in the natural-language input text with standardized vocabulary entries based on a transformation dictionary stored in the storage device.

11. The system according to claim 10, wherein the transformation dictionary is updated based on the stored interaction sets by identifying colloquial expressions that occur with a frequency exceeding a threshold across the plurality of stored interaction sets and adding corresponding standardized vocabulary entries to the transformation dictionary.

12. The system according to claim 1, wherein the circuitry is configured to detect, based on the emotion intensity value, that an emotion intensity exceeds an intensity threshold, and to modify the model input data to include an explicit intensity instruction that directs the generative model to produce output text reflecting a correspondingly elevated degree of emotional expression.

13. The system according to claim 12, wherein the intensity instruction comprises a numerical value representing the emotion intensity on a normalized scale, and wherein the model input data is formatted to embed the numerical value in a designated field recognized by the generative model as an intensity control parameter.

14. The system according to claim 1, wherein the circuitry is configured to compare the emotion type and the emotion intensity value of the revised input text against the emotion type and the emotion intensity value of the preceding natural-language input text, and to adjust the model input data for the current iteration based on a detected shift in emotion type or emotion intensity.

15. The system according to claim 14, wherein adjusting the model input data comprises inserting a continuity instruction into the model input data that directs the generative model to maintain thematic consistency with the generated text data from a preceding iteration when the detected shift is below an emotion shift threshold, and to generate text reflecting the updated emotional state when the detected shift exceeds the emotion shift threshold.

16. The system according to claim 1, wherein the circuitry is configured to retrieve, from the stored interaction sets, a previously stored interaction set whose structured data has a similarity to the structured data of the current natural-language input text exceeding a similarity threshold, and to incorporate a portion of the generated text data from the retrieved interaction set into the model input data as a stylistic reference.

17. The system according to claim 16, wherein similarity between structured data entries is computed as a cosine similarity between respective vector representations output by an encoder model applied to the structured data, and wherein the encoder model is stored in the storage device.

18. A system comprising:
circuitry configured to:
receive, via a communication interface coupled to a packet-switched network, natural-language input text from a terminal device and perform preprocessing on the natural-language input text to generate analysis data;
execute emotion analysis processing on the analysis data using a trained emotion analysis model to compute an emotion type and an emotion intensity value, and generate structured data encoding the emotion type, the emotion intensity value, and contextual parameters extracted from the natural-language input text;
construct model input data based on the structured data, transmit the model input data to a generative model via the communication interface, receive generated text data from the generative model, and transmit the generated text data to the terminal device; and
generate feedback data comprising evaluation information and improvement point information for the generated text data, transmit the feedback data to the terminal device, receive revised input text from the terminal device based on the feedback data, and repeat the processing for generating the model input data and receiving the generated text data.

19. The system according to claim 18, wherein the circuitry is configured to store interaction sets each comprising the natural-language input text, the model input data, the generated text data, and the feedback data in a storage device in association with user identification information, and to execute statistical processing on the stored interaction sets to update a generation condition for the model input data.

20. A method comprising:
receiving, via a communication interface coupled to a packet-switched network, natural-language input text from a terminal device, the natural-language input text representing a user's feelings or thoughts, and performing preprocessing on the natural-language input text, the preprocessing comprising at least tokenization, segmentation, and normalization, to generate analysis data;
executing emotion analysis processing on the analysis data using a trained emotion analysis model to compute an emotion type and an emotion intensity value represented in the natural-language input text, and generating structured data encoding the emotion type, the emotion intensity value, and contextual parameters extracted from the natural-language input text;
constructing model input data for a generative model based on the structured data, transmitting the model input data to the generative model via the communication interface, and receiving generated text data from the generative model, the generated text data expressing the feelings or thoughts indicated in the natural-language input text in a natural-language form;
generating feedback data comprising evaluation information and improvement point information for the generated text data based on the natural-language input text and the generated text data, and transmitting the generated text data and the feedback data to the terminal device via the communication interface;
receiving revised input text from the terminal device as a new prompt sentence based on the feedback data, and repeating the processing for generating the model input data, receiving the generated text data, and generating the feedback data; and
storing, in a storage device, interaction sets each comprising the natural-language input text, the model input data, the generated text data, and the feedback data in association with user identification information, and executing statistical processing or machine learning processing on a plurality of stored interaction sets to update at least one of a generation condition for the model input data and a generation condition for the feedback data.
